(19) United States
(12) Patent Application Publication
(10) Pub. No.: US 2009/0099382 A1
(43) Pub. Date: Apr. 16, 2009

(54) ACTIVE INGREDIENT CARRIERS WHICH ARE BASED ON SILICON AND CONTAIN AMINOALKYL GROUPS

(75) Inventors: Thomas Gerke, Neuss (DE); Andreas Bauer, Kaarst (DE); Ralf Bunn, Krefeld (DE); Werner Faber, Willich (DE); Wolfgang Lahn, Willich (DE); Alfred-Michael Lusse, Holzminden (DE); Mannuela Materne, Kaarst (DE); Theo Ten Pierik, venlo (NZ); Frank Rittler, Dusseldorf (DE); Hubert Smyrek, Krefeld (DE)

Correspondence Address: CONNOLLY BOVE LODGE & HUTZ LLP, PO BOX 2207, WILMINGTON, DE, 19899-2207, US

(73) Assignee: HENKEL AG & CO. KGAA, Duesseldorf (DE)

(21) Appl. No.: 12/282,035

(22) PCT Filed: Mar. 2, 2007
(86) PCT No.: PCT/EP2007/001788

§ 371 Date: Nov. 20, 2008

(30) Foreign Application Priority Data
Mar. 8, 2006 (DE) 10 2006 011 087.0

(51) Int. Cl. C07F 7/02

(52) U.S. Cl. 556/464; 556/482

(57) ABSTRACT

Silicon compounds comprising at least one silicon atom, at least one alkoxy group of the formula —OR′ bonded to silicon, and at least one aminoalkyl group bonded to silicon, wherein the alkoxy group is derived from an active substance alcohol of the formula R′OH, and the use thereof for perfuming or preserving laundry detergents and cleaners or cosmetic compositions.

The present invention relates to monomeric and oligomeric silicon compounds, wherein at least one fragrance- or biocide-alkoxy group and also at least one optionally chemically modified aminoalkyl or aminoalkoxy group are bonded to the silicon, and also the use of these compounds for perfuming or preserving detergents and cleaners or cosmetic compositions.

The controlled release of ingredients in the most varied of preparations is the subject matter of numerous publications and patent applications. In the field of detergents and cleaners, accelerated or delayed release of ingredients from the group of bleaching agents, bleach activators, surfactants etc. is of particular interest. In this field, the release of fragrances is of paramount significance because both the product as well as the detergent and cleaning solution and the articles treated with these compositions should be intensively and long-lastingly perfumed. Besides applying perfumes to carrier materials and coating the perfumed carriers or encapsulating perfumes or incorporating them in compounds (for example cyclodextrin/perfume complexes), perfumes can be chemically bound to carrier media, the chemical bond being slowly broken and the perfume being released. This principle has been put into practice, for example, in the esterification of fragrance alcohols, a broad prior art being available on this group of substances.

It is known from the prior art that perfume alcohols can be bound to non-volatile siloxanes from which they are slowly released by hydrolysis. Although a broad prior art also exists on the subject of siloxane esters of fragrance alcohols, problems arise where the compounds mentioned are used in detergents and cleaners. Thus, many of the known compounds cannot be used in aqueous detergents and cleaners because they hydrolyze in the product itself so that the delayed release no longer occurs. This is all the more frequent as conventional detergents and cleaners often have pH values which further intensify the hydrolysis process. However, known siloxane esters cannot always be incorporated in powdered detergents and cleaners. Under typical production conditions for compacted particle mixtures, such as granulation or press agglomeration, the siloxane esters also tend to release the fragrance alcohol during the actual production process, i.e. prematurely. Accordingly, there is a need to provide fragrances in supply forms which perfume both the product as well as the wash liquor and substrates treated with the products, wherein the fragrance should persist for as long as possible on textiles in particular.

Monomeric orthosilicic acid esters of fragrance alcohols are described, for example, in U.S. Pat. No. 3,215,719 (Dan River Mills). This document also mentions the delayed release of fragrant alcohols from mixed esters such as, for example, bis(eugenoxy) diethoxy silane or bis(cinnamoyloxy) diethoxy silane, the central Si atom not necessarily having to be bound to oxygen only. Groups that include aminoalkyl groups are not mentioned in this document, however.

Powdered or granular detergent and cleaner compositions that contain “perfuming” silicon compounds are described in DE 28 44 789 (Dow Corning). The mono-, oligo- and polymeric silicon compounds disclosed in this document do not necessarily have to contain a central Si atom surrounded by four oxygen atoms. Although groups containing aminoalkyl groups are listed in the description as possible substituents, however no compounds are explicitly disclosed that include groups containing aminoalkyl groups.

Liquid or pasty soap compositions that contain “perfuming” silicon compounds are described in DE 3003494 (Dow Corning). Groups containing aminoalkyl groups are also not explicitly disclosed in this document.

Monomeric silicon compounds that include at least one fragrance alkoxy group and at least one alkyl group are described in EP 982313 (General Electric). Groups that include aminoalkyl groups are not disclosed, however.

Oligomeric and polymeric silicon compounds that can also include alkyl groups in addition to fragrance alkoxy groups are disclosed in DE 19750706. Groups that include aminoalkyl groups are also not disclosed here, however.

Furthermore, oligomeric and polymeric silicic acid esters are disclosed in the patents WO00/14091 and WO01/68037. However, groups containing aminoalkyl groups are not disclosed here either.

The problem that previously existed in the above-cited patents has already been partially solved by the provision of carrier-bound forms of fragrance alcohols to enable a controlled release of the fragrances. However, a further problem resulted for some embodiments, in that the controlled release of the fragrances from the carrier-bound forms did not occur with the desired regularity.

Accordingly, a first object of the present invention was to provide carrier-bound forms of fragrance alcohols, which can also be incorporated in aqueous detergents and cleaners, without already excessive signs of hydrolysis in the product. Another requirement to be satisfied by the compounds was that they should lend themselves to incorporation in granular detergent and cleaner compositions without decomposing in the production process. The compounds to be produced should impart a pleasant and long-lasting fragrance to the substrates treated with the solution.

Accordingly, a further object of the present invention was also however to preferably provide such hydrolysis-stable carrier-bound forms of fragrance alcohols, which enable the bound fragrances to be released with the highest possible regularity.

Furthermore, a further object of the present invention was to provide such carrier-bound forms of fragrance alcohols, which, due to their release kinetics, could be particularly advantageously combined with the already known carrier-bound forms of fragrance alcohols and/or with non carrier-bound forms of fragrance alcohols.

It has now been found that silicon compounds that include, in addition to fragrance alcohols bound in the alkoxy form, a group that includes an aminoalkyl group, show a particularly advantageous behavior in regard to the release kinetics of the fragrance alcohol, and thereby achieve the objects cited previously.

In the investigations, it was surprisingly found that the fragrance alcohols are released by means of these compounds in a uniform manner both in the product and also at the active site. In addition, it was surprisingly found that these compounds in combination with conventional fragrances also impart a longer-lasting effect to the fragrances that are not present in carrier-bound form. Independently of the chemical composition of the fragrances, the compounds according to the invention can thus be employed in fragrance mixtures so as to impart a prolonged fragrance release to the perfume composition as a whole.

Moreover, it further appears that the compounds according to the invention can also be advantageously employed particularly in combination with other carrier-bound forms of fragrances. In this connection, the combined use of compounds according to the invention and silicic acid esters of fragrance alcohols turns out to be particularly advantageous. If the compounds according to the invention are employed in combination with silicic acid esters then this enables an adequate uniform release of the fragrance over an even longer period of time.

As the release kinetics for other active alcohols, particularly biocide alcohols are similar, then according to the invention, to obtain a uniform release of another active substance, silicon compounds containing a group that includes an aminoalkyl group can be correspondingly employed, on which instead of, or beside fragrance alkoxy groups, other active alkoxy groups, in particular biocide alkoxy groups are bonded. A constant preservation action can be obtained for example by using compounds according to the invention with biocide alkoxy groups.

Accordingly, a first subject matter of the present invention is a silicon compound, wherein at least one alkoxy group of the formula —OR′ as well as at least one group that includes an aminoalkyl group is bonded to the silicon, wherein R′OH stands for an active substance alcohol, in particular for a fragrance alcohol or biocide alcohol.

In this connection, the silicon compound is preferably a compound of Formula I,

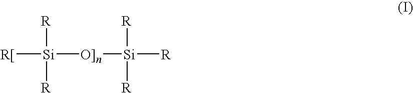

in which at least one of the R groups stands for an active substance alcohol group, in particular for a fragrance alcohol group or a biocide alcohol group which is bonded in alkoxy form to the silicon, and wherein at least one of the remaining R groups stands for a group having a straight chain or branched, saturated or unsaturated, substituted or unsubstituted as well as optionally chemically modified aminoalkyl group, and wherein those R groups that stand neither for a fragrance alcohol group nor biocide alcohol group nor a group that has an aminoalkyl group, are selected independently of one other from hydrogen, hydroxyl and from the group of the straight chain or branched, saturated or unsaturated, substituted or unsubstituted alkyl and alkoxy groups, wherein two R groups that are bonded to different silicon atoms can also represent an oxygen atom that bridges both these silicon atoms, and wherein n can assume a value of 0 to 20.

In a particularly preferred embodiment, n is equal to 0, exactly one of the R groups stands for a group that has an aminoalkyl group and the remaining R groups stand for alkoxy groups, wherein at least one, preferably at least two of the alkoxy groups are alkoxy groups of fragrance alcohols.

In further preferred embodiments, n assumes a value of 1 to 14, preferably from 1 to 11 and especially from 2 to 8, with particular preference for the values 3, 4, 5, 6 and 7.

The group that includes an aminoalkyl group is preferably an aminoalkyl group that is bonded to the silicon atom through a Si—C bond. However, the group that includes an aminoalkyl group can also be an aminoalkoxy group, for example.

The aminoalkyl group of a group that includes an aminoalkyl group is preferably a straight chain or branched, saturated or unsaturated, substituted or unsubstituted C₁₋₂₂ aminoalkyl group. In this connection, the aminoalkyl group is particularly preferably selected from aminomethyl, aminoethyl, amino-n-propyl, amino-iso-propyl, amino-n-butyl, amino-iso-butyl and amino-tert-butyl, wherein if a plurality of aminoalkyl groups is present in the compound, they can be selected independently of each other. The aminoalkyl group can also optionally comprise additional heteroatoms as well as cyclic or aromatic groups.

The fragrance alcohol groups comprised in the silicon compound can be identical or different, but in a preferred embodiment are identical. Similarly, the groups that include aminoalkyl groups, which are comprised in the silicon compound, can be identical or different, in so far as a plurality is present. Here it is also preferred that all the comprised groups that include aminoalkyl groups are identical.

The compounds according to the invention are produced by simple transesterification of fragrance alcohols with aminoalkyl group-substituted silicon compounds that carry alkoxy groups of lower alcohols, wherein both individual fragrance alcohols as well as mixtures of fragrance alcohols may be used. Transesterifications such as these may be carried out, for example, as described in the article by H. Steinmann, G. Tschernko and H. Hamann in Z. Chem. 3, 1977, pp. 89-92. Depending on the reaction time and conditions, the lower alcohols are eliminated and the fragrance alcohols are bound, wherein the aminoalkyl groups bonded through a Si—C bond are retained. The transesterification reaction may be controlled solely by increasing the temperature and distilling off the readily volatile by-products; however, catalysts are preferably used for the transesterification. The catalysts used are typically Lewis acids, preferably aluminum tetraisopropylate, titanium tetraisopropylate, silicon tetrachloride or basic catalysts or even preparations, for example of aluminum chloride with potassium fluoride. The thus formed silicon compounds then at least partly contain fragrance alcohol groups and/or biocide alcohol groups or a combination of the two. However, the resulting compounds normally also contain residues of lower alcohols. If small quantities of water or other H-acidic compounds are present during the production, then alcohol groups are also replaced by OH groups. Accordingly, the compounds according to the invention also eventually partly contain hydroxyl groups as the substituent R.

Aminoalkyl group-substituted silicon compounds bearing alkoxy groups of lower alcohols are commercially obtainable, wherein the lower alcohol groups are usually selected from the groups from methanol, ethanol, n-propanol, isopropanol, n-butanol, isobutanol and tert.butanol. The synthesis of silicon compounds that are incompletely transesterified with fragrance alcohols therefore leads to mixtures in which a part of the substituents R is selected from the group methoxy, ethoxy, n-propoxy, isopropoxy, n-butoxy, isobutoxy and tert.butoxy. Such compounds are preferred in the context of the present invention. Suitable starting compounds for the reaction with fragrance alcohols are available, for example, from Wacker Chemie (Burghausen, Germany) under the trade names

Geniosil® GF 91 (N-(2-aminoethyl)-3-aminopropyl trimethoxy silane),
Geniosil® GF 92 (N-cyclohexyl-3-aminopropyl trimethoxy silane),
Geniosil® GF 95 (N-(2-aminoethyl)-3-aminopropyl methyl dimethoxy silane),
Geniosil® GF 96 (3-aminopropyl trimethoxy silane) or
Geniosil® XL 926 (N-cyclohexylaminomethyl triethoxy silane).

In the group that includes the aminoalkyl group, the amino group can be a primary, secondary or tertiary amino group, primary amino groups being preferred. In a preferred embodiment, the amino group is employed in an unmodified state, although it can also be optionally modified. In this connection, quaternization of the amino group and the formation of a Schiff's Base by reaction with aldehydes come into consideration as a chemical modification. The aldehydes are preferably selected from active substance aldehydes, especially from fragrance aldehydes or biocide aldehydes.

According to the invention, active substance alcohols are understood to mean alcohols that are intended to develop a defined effect in the composition in which they are comprised, or at the place of application onto which the composition is applied. In this connection, preferred active substance alcohols are fragrance alcohols and biocide alcohols. “Fragrance alcohols” are understood to be compounds that contain at least one hydroxyl group and convey an impression of fragrance, whereas biocide alcohols are understood to mean compounds that contain at least one hydroxyl group and possess biocidal activity or at least inhibit germ growth.

The following compounds may be named as examples of fragrance alcohols: 10-undecen-1-ol, 2,6-dimethyl heptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 1-octen-3-ol, 3-phenylpropanol, 4-heptenol, 4-isopropylcyclohexanol, 4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, β-terpineol, butyl salicylate, citroneliol, cyclohexyl salicylate, decanol, dihydromyrcenol, dimethylbenzylcarbinol, dimethylheptanol, dimethyloctanol, ethyl salicylate, ethyl vanillin, eugenol, geraniol, heptanol, hexyl salicylate, isoborneol, isoeugenol, isopulegol, linalool, menthol, myrtenol, n-hexanol, nerol, nonanol, octanol, para-menthan-7-ol, phenylethyl alcohol, phenol, phenyl salicylate, tetrahydrogeraniol, tetrahydrolinalool, thymol, trans-2-cis-6-nonadienol, trans-2-nonen-1-ol, trans-2-octenol, undecanol, vanillin, cinnamyl alcohol, wherein, if a plurality of fragrance alcohols is present, they can be selected independently from each other.

Exemplary biocide alcohols are citronellol, eugenol, farnesol, thymol and geraniol. Additional biocide alcohols are phenoxyethanol, 1,2-propylene glycol, glycerol, citric acid and its esters, lactic acid and its esters, salicylic acid and its esters, 2-benzyl-4-chlorophenol and 2,2′-methylene-bis-(6-bromo-4-chlorophenol). In the context of this invention, the lower alcohols that were already cited earlier as the typical alkoxy groups of the silicon compounds are not considered as biocide alcohols. Explicitly, methyl-, ethyl-, n-propyl-, iso-propyl-, n-butyl-, iso-butyl- and tert.-butyl alcohol are not considered according to the invention as biocide alcohols. On the other hand, according to the invention, classical biocides with alcohol functions are expressly considered to be biocide alcohols, even if their action is attributed to other functional groups. Examples of these are various bromophenols and biphenylois as well as quaternary ammonium compounds having at least one long chain alkyl group and at least one alkyl group that carries a hydroxyl group.

According to the invention, active substance aldehydes are understood to mean aldehydes that are intended to develop a defined effect in the composition in which they are comprised, or at the place of application onto which the composition is applied. In this connection, preferred active substance aldehydes are fragrance aldehydes and biocide aldehydes. Fragrance aldehydes are understood to mean aldehydes that convey an impression of fragrance, whereas biocide aldehydes are understood to mean aldehydes with biocidal activity.

Preferred representatives can be named from the extensive group of the fragrance aldehydes: octanal, citral, melonai, lilial, floralozon, canthoxal, 3-(4-ethylphenyl)-2,2-dimethylpropanal, 3-(4-methoxyphenyl)-2-methylpropanal, 4-(4-hydroxy-4-methylpentyl)-3-cyclohexen-1-carboxaldehyd, phenylacetaldehyde, methylnonylacetaldehyde, 2-phenylpropan-1-al, 3-phenylprop-2-en-1-al, 3-phenyl-2-pentylprop-2-en-1-al, 3-phenyl-2-hexylprop-2-enal, 3-(4-Isopropylphenyl)-2-methylpropan-1-al, 3-(4-ethylphenyl)-2,2-dimethylpropan-1-al, 3-(4-tert-butylphenyl)-2-methyl-propanal, 3-(3,4-methylendioxyphenyl)-2-methylpropan-1-al, 3-(4-ethylphenyl)-2,2-dimethylpropanal, 3-(3-isopropylphenyl)butan-1-al 2,6-dimethylhept-5-en-1-al, n-decanal, n-undecanal, n-dodecanal, 3,7-dimethyl-2,6-octadien-1-al, 4-methoxybenzaldehyde, 3-methoxy-4-hydroxybenzaldehyde, 3-ethoxy-4-hydroxybenzaldehyde, 3,4-methylendioxybenzaldehyde and 3,4-dimethoxybenzaldehyde.

As further employable fragrance aldehydes may be cited: adoxal, anisaldehyde, cumal, ethylvanillin, florhydral, helional, heliotropin, hydroxycitronellal, koavon, laurylaldehyde, lyral, methylnonylacetaldehyde, bucinal, phenylacetaldehyde, undecylenaldehyde, vanillin, 2,6,10-trimethyl-9-undecenal, 3-dodecen-1-al, α-n-amylcinnamaldehyde, 4-methoxybenzaldehyde, benzaldehyde, 3-(4-tert.butylphenyl)-propanal, 2-methyl-3-paramethoxyphenylpropanal, 2-methyl-4-(2,6,6-trimethyl-2(l)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzaldehyde, 1,2,3,4,5,6,7,8-octahydro-8,8-dimethyl-2-naphthaldehyde, 2,4-dimethyl-3-cyclohexen-1-carboxaldehyde, 1-decanal, decylaldehyde, 2,6-dimethyl-5-heptenal, 4-(tricyclo[5.2.1.0(2,6)]-decyliden-8)-butanal, octahydro-4,7-methano-1-indenecarboxaldehyde, 3-ethoxy-4-hydroxybenzaldehyde, para-ethyl-α,α-dimethyl hydrocinnamaldehyde, α-methyl-3,4-(methylenedioxy)-hydrocinnamaldehyde, 3,4-methylenedioxybenzaldehyde, α-n-hexylcinnamaldehyde, m-cumene-7-carboxaldehyde, α-methylphenylacetaldehyde, 7-hydroxy-3,7-dimethyloctanal, undecenal, 2,4,6-trimethyl-3-cyclohexen-1-carboxaldehyde, 4-(3)(4-methyl-3-pentenyl)-3-cyclohexenecarboxaldehyde, 1-dodecanal, 2,4-dimethyl-cyclohexene-3-carboxaldehyde, 4-(4-hydroxy-4-methylpentyl)-3-cylohexen-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert.butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1 or 2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3,7-dimethyl-octanal, trans-4-decenal, 2,6-nonadienal, para-tolylacetaldehyde, 4-methylphenylacetaldehyde, 2-methyl-4-(2,6,6-trimethyl-1-cyclohexen-1-yl-butenal, ortho-methoxycinnamaldehyde, 3,5,6-trimethyl-3-cyclohexenecarboxaldehyde, 3,7-dimethyl-2-methylene-6-octenal, phenoxyacetaldehyde, 5,9-dimethyl-4,8-decadienal, peonyaldehyde (6,10-dimethyl-3-oxa-5,9-undecadien-1-al), hexahydro-4,7-methanoindane-1-carboxaldehyde, 2-methyloctanal, α-methyl-4-(1-methylethyl)benzeneacetaldehyde, 6,6-dimethyl-2-norpinen-2-propionaldehyde, para-methylphenoxyacetaldehyde, 2-methyl-3-phenyl-2-propen-1-al, 3,5,5-trimethyl hexanal, hexahydro-8,8-dimethyl-2-naphthaldehyde, 3-propyl-bicyclo[2.2.1]-hept-5-en-2-carbaldehyde, 9-decenal, 3-methyl-5-phenyl-1-pentanal and methylnonylacetaldehyde.

In regard to inventively employable aldehydes, reference is made to the following literature: Steffen Arctander, Aroma Chemicals Vol. 1 (1960, reprinted 2000) ISBN 0-931710-37-5 und Aroma Chemicals Vol. 2 (1969, reprinted 2000) ISBN 0-931710-38-3.

The following compounds may be named as examples of biocide aldehydes: formaldehyde, paraformaldehyde, propenal (acrolein), glyoxal and glutaraldehyde.

According to the invention, branched, saturated or unsaturated, substituted or unsubstituted alkyl or alkoxy groups are understood to mean all types of alkyl and alkoxy groups that can also comprise hetero atoms as well as cyclic and aromatic groups. In a preferred embodiment, however, they concern C₁₋₄ alkyl or C₁₄ alkoxy groups, wherein C₁₋₄ alkoxy groups are particularly preferred, as these, due to the above cited preferred manufacturing process can be preferably comprised, optionally also in addition to hydroxyl groups.

A delayed release of fragrance alcohols is particularly desired in detergents and cleaners as well as in cosmetics, as here a longer fragrant impression should be achieved at the place of application, i.e. on the treated textile or on the skin or the hair.

The silicon compounds according to the invention are characterized by their good hydrolysis stability and can also be employed in aqueous media or in manufacturing processes for granulates without thereby suffering excessive loss in activity. Accordingly, liquid detergent and cleaning compositions, such as liquid detergents, fabric softeners, manual dishwashing detergents, cleaning compositions for hard surfaces, floor cleaners etc. are as conceivable as solid detergent and cleaning compositions, for example granular laundry detergents, dishwasher detergents or scouring compositions. The silicon compounds according to the invention may also be used in cosmetic skin and hair care preparations. These may again be both liquid preparations, for example shower baths, deodorants and hair shampoos, and solid preparations, for example bar soaps.

Accordingly, a further subject matter of the present invention is also the use of silicon compounds according to the invention as the fragrance in liquid or solid detergents and cleaning compositions as well as the use of silicon compounds according to the invention as the fragrance in cosmetic skin or hair care preparations.

Consequently, a further subject matter of the present invention also concerns detergents or cleaning compositions as well as cosmetic skin or hair care preparations, which comprise the silicon compounds according to the invention.

For use in the detergents and cleaning compositions and in the cosmetics, the silicon compound is preferably added in amounts of 0.001 to 10 wt. %, particularly preferably 0.01 to 5 wt. %, particularly 0.02 to 3 wt. % and especially 0.05 to 2 wt. %, each based on the total composition.

The silicon compounds according to the invention can be employed as the sole fragrance, but it is also possible to employ mixtures of fragrances that only partially consist of the silicon compounds according to the invention. Such mixtures have the advantage that the ingredients of the fragrance mixture, which are not present in the fragrance alkoxy form, are also improved in the endurance of the fragrance impression. Thus in particular, mixtures of fragrances can be employed, which comprise 1 to 50 wt. %, preferably 5 to 40 and especially maximum 30 wt. % of the silicon compounds according to the invention. In other embodiments, in which in particular the delayed fragrance effect of the esterified fragrance alcohols should be utilized, advantageously at least 30 wt. %, preferably at least 40 wt. % and especially at least 50 wt. % of the total of the perfume comprised in the composition are incorporated in the inventive process into the composition through the silicon compounds according to the invention, whereas the remaining 70 wt. %, preferably 60 wt. % and especially 50 wt. % of the total of the perfume comprised in the composition are sprayed on in a conventional way or incorporated in another way into the composition. The use according to the invention can also be characterized in that the silicon compounds according to the invention are employed together with other fragrances, wherein these can be present in both carrier-bound form as well as in non carrier-bound form.

In this connection, the combination with silicic acid esters has proven to be particularly advantageous. As already mentioned, a sustained, uniform release of the active substance alcohol over a long period is achieved, particularly for the combined employ of the silicon compounds according to the invention and silicic acid esters.

In this connection, the silicic acid ester is preferably a compound of the general Formula II

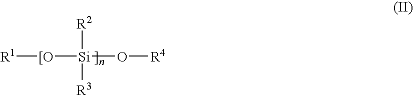

in which R¹ and R⁴ independently of one another are selected from the group of linear or branched, saturated or unsaturated, substituted or unsubstituted C₁₋₆ hydrocarbon groups and the active substance alcohols, particularly the fragrance alcohol groups and biocide alcohol groups, each R² and R³ independently of one another is selected from the group of the active substance alcohol groups particularly the fragrance alcohol groups and biocide alcohol groups, wherein any two groups R² and R³ that are bonded to different silicon atoms can also represent a bridging oxygen atom between these two silicon atoms, and n assumes a value between 2 and 20. In regard to the inventively preferred silicic acid esters, reference is particularly made to the patents WO00/14091 and WO01/68037.

By dividing the total perfume content of the compositions into perfume present in the silicon compounds and conventionally incorporated perfume, it is possible to realize a number of product features that are only made possible through the use according to the invention. Thus, for example it is conceivable and possible to divide the total perfume content of the compositions into two portions x and y, portion x consisting of tenacious perfume oils, i.e. less volatile perfume oils, and portion y consisting of more volatile perfume oils.

Now, it is possible, for example, to produce detergent or cleaning compositions where the percentage of perfume introduced into the compositions through the silicon compounds according to the invention is mainly made up of tenacious perfumes. In this way, tenacious perfumes that are intended to perfume the treated articles, more especially textiles, are “retained” in the product and thus develop their effect primarily on the treated laundry. By contrast, the more readily volatile perfumes contribute towards more intensive perfuming of the compositions per se. In this way, it is also possible to produce detergents and cleaning compositions that, as compositions, have an odor that differs from the odor of the treated articles. There are virtually no limits in this regard to the creativity of perfumists because almost limitless possibilities exist for perfuming the compositions, firstly through the choice of the odoriferous substances and secondly through the choice of the method used to incorporate them into the compositions, and—through the compositions—the articles treated with them.

The principle described above can of course also be reversed by incorporating the more readily volatile odoriferous substances into the silicon compounds and spraying or otherwise incorporating the less volatile tenacious odoriferous substances onto the compositions. In this way, the loss of the more readily volatile odoriferous substances from the packaging during storage and in transit is minimized, while the fragrance characteristic of the detergents is determined by the tenacious odoriferous substances.

The only limiting aspect of this procedure is that the fragrances to be introduced via the silicon compounds according to the invention emanate from the group of fragrance alcohols. The fragrances conventionally incorporated in the compositions are not subject to any limitations. Thus, individual odoriferous compounds, for example synthetic products of the ester, ether, aldehyde, ketone, alcohol and hydrocarbon type, can be used as the perfume oils or fragrances. Odoriferous compounds of the ester type are, for example, benzyl acetate, phenoxyethyl isobutyrate, p-tert.-butylcyclohexyl acetate, linalyl acetate, dimethylbenzyl carbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate and jasmecyclate. The ethers include, for example, benzyl ethyl ether and ambroxan; the aldehydes include, for example, the linear alkanals containing 8 to 18 carbon atoms, citral, citronellal, citronellyloxyacetaldehyde, cyclamen aldehyde, lilial and bourgeonal; the ketones include, for example, the ionones, α-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various odoriferous substances, which together produce an attractive fragrant note, are preferably used.

Perfume oils such as these may also contain natural mixtures of odoriferous substances, as are obtainable from vegetal sources, for example pine, citrus, jasmine, patchouli, rose or ylang-ylang oil. Also suitable are muscatel sage oil, chamomile oil, clove oil, melissa oil, mint oil, cinnamon leaf oil, lime blossom oil, juniper berry oil, vetivert oil, olibanum oil, galbanum oil and laudanum oil and orange blossom oil, neroli oil, orange peel oil and sandalwood oil.

The general description of the employable perfumes (see above) generally illustrates the different substance classes of odoriferous substances. The volatility of an odoriferous substance is crucial for its perceptibility, whereby in addition to the nature of the functional groups and the structure of the chemical compound, the molecular weight also plays an important role. Thus, the majority of odoriferous substances have molecular weights up to 200 daltons, and molecular weights of 300 daltons and above are quite an exception. Due to the different volatilities of odoriferous substances, the smell of a perfume or fragrance composed of a plurality of odoriferous substances changes during evaporation, the impressions of odor being subdivided into the “top note”, “middle note” or “body” and “end note” or “dry out”. As the perception of smell also depends to a large extent on the intensity of the odor, the top note of a perfume or fragrance consists not solely of highly volatile compounds, whereas the endnote consists to a large extent of less volatile, i.e. tenacious odoriferous substances. In the composition of perfumes, higher volatile odoriferous substances can be bound, for example onto particular fixatives, whereby their rapid evaporation is impeded. The above-described embodiment of the present invention, in which the more readily volatile odoriferous substances or fragrances are incorporated in the silicon compounds according to the invention, is one such method of fixing an odoriferous substance. In the following subdivision of odoriferous substances into “more volatile” or “tenacious” odoriferous substances, nothing is mentioned about the odor impression and further, whether the relevant odoriferous substance is perceived as the top note or body note.

Exemplary tenacious odorous substances that can be used in the context of the present invention are the ethereal oils such as angelica root oil, aniseed oil, arnica flowers oil, basil oil, bay oil, bergamot oil, champax blossom oil, silver fir oil, silver fir cone oil, elemi oil, eucalyptus oil, fennel oil, pine needle oil, galbanum oil, geranium oil, ginger grass oil, guaiacum wood oil, Indian wood oil, helichrysum oil, ho oil, ginger oil, iris oil, cajuput oil, sweet flag oil, camomile oil, camphor oil, Canoga oil, cardamom oil, cassia oil, Scotch fir oil, copaiba balsam oil, coriander oil, spearmint oil, caraway oil, cumin oil, lavender oil, lemon grass oil, limette oil, mandarin oil, melissa oil, amber seed oil, myrrh oil, clove oil, neroli oil, niaouli oil, olibanum oil, orange oil, origanum oil, Palma Rosa oil, patchouli oil, Peru balsam oil, petit grain oil, pepper oil, peppermint oil, pimento oil, pine oil, rose oil, rosemary oil, sandalwood oil, celery seed oil, lavender spike oil, Japanese anise oil, turpentine oil, thuja oil, thyme oil, verbena oil, vetiver oil, juniper berry oil, wormwood oil, wintergreen oil, ylang-ylang oil, ysop oil, cinnamon oil, cinnamon leaf oil, citronella oil, citrus oil and cypress oil. However, in the context of the present invention, the higher boiling or solid odoriferous substances of natural or synthetic origin can be used as tenacious odoriferous substances or mixtures thereof, namely fragrances. These compounds include the following compounds and their mixtures: ambrettolide, α-amyl cinnamaldehyde, anethol, anisaldehyde, anis alcohol, anisole, methyl anthranilate, acetophenone, benzyl acetone, benzaldehyde, ethyl benzoate, benzophenone, benzyl alcohol, benzyl acetate, benzyl benzoate, benzyl formate, benzyl valeriate, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, methyl heptyne carboxylate, heptaldehyde, hydroquinone dimethyl ether, hydroxycinnamaldehyde, hydroxycinnamyl alcohol, indole, irone, isoeugenol, isoeugenol methyl ether, isosafrol, jasmone, camphor, carvacrol, carvone, p-cresol methyl ether, coumarone, p-methoxyacetophenone, methyl-n-amyl ketone, methyl anthranilic acid methyl ester, p-methyl acetophenone, methyl chavicol, p-methyl quinoline, methyl-β-naphthyl ketone, methyl-n-nonyl acetaldehyde, methyl-n-nonyl ketone, muscone, β-naphthol ethyl ether, β-naphthol methyl ether, nerol, nitrobenzene, n-nonyl aldehyde, nonyl alcohol, n-octyl aldehyde, p-oxyacetophenone, pentadecanolide, p-phenyl ethyl alcohol, phenyl acetaldehyde dimethyl acetal, phenyl acetic acid, pulegone, safrol, isoamyl salicylate, methyl salicylate, hexyl salicylate, cyclohexyl salicylate, santalol, scatol, terpineol, thymine, thymol, γ-undecalactone, vanillin, veratrum aldehyde, cinnamaldehyde, cinnamyl alcohol, cinnamic acid, ethyl cinnamate, benzyl cinnamate.

The readily volatile odoriferous substances particularly include the low boiling odoriferous substances of natural or synthetic origin that can be used alone or in mixtures. Exemplary readily volatile odoriferous substances are diphenyl oxide, limonene, linalool, linalyl acetate and linalyl propionate, melusat, menthol, menthone, methyl n-heptenone, pinene, phenyl acetaldehyde, terpinyl acetate, citral, citronellal.

The detergent or cleaning composition according to the invention can be, for example, a composition in liquid or gel form, in particular a liquid detergent or a liquid dishwasher detergent or a cleaning gel, in particular a cleaning agent in gel form for toilet rinses.

Moreover, it can be for example a cleaner from the group of the liquid or gel-like cleaners for hard surfaces, in particular a so called all purpose cleaner, floor or bathroom cleaner as well as specific embodiments of this type of cleaner, which include acid or alkaline forms of all purpose cleaners, likewise as glass cleaners with so called anti-rain effect.

For the liquid detergent or cleaning composition, in particular it can be a cleaning composition that has a plurality of phases, especially two phases.

The detergent or cleaning composition can also be a powdered or granular composition, however. Moreover, the detergent or cleaning composition can also for example be in the form of molded articles, preferably as tablets that can consist of a single or of a plurality of phases, especially 2 or 3 different phases.

The cosmetic compositions can be an aqueous preparation that comprises surfactants and is particularly suitable for treating keratinic fibers, particularly human hair, or for treating skin. However, it can also be a molded article, for example, that comprises surface-active ingredients. In particular embodiments it can be a composition for influencing the body odor, in particular a deodorant, or a hair setting composition that comprises polymers for setting, preferably comprising at least one polyurethane.

In addition to the fragrances, the detergents and cleaning compositions can obviously comprise the conventional ingredients of such compositions. Here, principally surfactants, builders as well as bleaching agents, enzymes and other active substances are to be cited. In this connection, the key ingredients of detergents and cleaning compositions include surfactants in particular.

The surfactant content selected for the compositions according to the invention will be relatively high or relatively low according to the intended application. The surfactant content of detergents is normally between 10 and 40% by weight, preferably between 12.5 and 30% by weight and more particularly between 15 and 25% by weight whereas dishwasher detergents contain between 0.1 and 10% by weight, preferably between 0.5 and 7.5% by weight and more particularly between 1 and 5% by weight of surfactants.

These surface-active substances emanate from the group of anionic, non-ionic, zwitterionic or cationic surfactants, anionic surfactants being markedly preferred for economic reasons and on the grounds of their performance spectrum in washing and cleaning.

Exemplary suitable anionic surfactants are those of the sulfonate and sulfate type. Suitable surfactants of the sulfonate type are, advantageously C₉₋₁₈ alkylbenzene sulfonates, olefin sulfonates, i.e. mixtures of alkene- and hydroxyalkane sulfonates and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofafty acids (ester sulfonates), e.g. the α-sulfonated methyl esters of hydrogenated coco-, palm nut- or tallow fatty acids are likewise suitable.

Further suitable anionic surfactants are sulfated fatty acid esters of glycerine. They include the mono-, di- and triesters and also mixtures of them, such as those obtained by the esterification of a monoglycerine with 1 to 3 moles fatty acid or the transesterification of triglycerides with 0.3 to 2 moles glycerine. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali metal and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C10-C20 oxo alcohols and those half-esters of secondary alcohols of these chain lengths. Additionally preferred are alk(en)yl sulfates of the said chain lengths, which contain a synthetic, straight-chained alkyl group produced on a petrochemical basis and which show similar degradation behaviour to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of laundry performance. The 2,3-alkyl sulfates, which are manufactured according to the U.S. Pat. No. 3,234,258 or U.S. Pat. No. 5,075,041, and which can be obtained as commercial products from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO. Due to their high foaming performance, they are only used in fairly small quantities in cleaning compositions, for example in amounts of 1 to 5% by weight.

Other suitable anionic surfactants are the salts of alkylsulfosuccinic acids, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates comprise C₈₋₁₈ fatty alcohol groups or mixtures of them. Especially preferred sulfosuccinates comprise a fatty alcohol group derived from ethoxylated fatty alcohols and may be considered as non-ionic surfactants (see description below). Once again the especially preferred sulfosuccinates are those, whose fatty alcohol groups are derived from ethoxylated fatty alcohols with narrow range distribution. It is also possible to use alk(en)ylsuccinic acids with preferably 8 to 18 carbon atoms in the alk(en)yl chain, or salts thereof.

Soaps in particular can be considered as further anionic surfactants. Saturated fatty acid soaps are suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid.

Anionic surfactants, including soaps may be in the form of their sodium, potassium or ammonium salts or as soluble salts of organic bases, such as mono-, di- or triethanolamine. Preferably, the anionic surfactants are in the form of their sodium potassium or magnesium salts, especially in the form of the sodium salts.

So far as the choice of anionic surfactants is concerned, there are no basic limits to restrict the freedom of formulation. However, preferred detergent compositions do have a soap content in excess of 0.2% by weight, based on the total weight of the detergent and cleaning composition produced in step d). Preferred anionic surfactants are alkyl benzenesulfonates and fatty alcohol sulfates, wherein preferred detergent tablets contain 2 to 20% by weight, preferably 2.5 to 15% by weight and more preferably 5 to 10% by weight of fatty alcohol sulfate(s), based on the weight of the composition.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched groups in the form of the mixtures typically present in oxo alcohol groups. Particularly preferred are, however, alcohol ethoxylates with linear groups from alcohols of natural origin with 12 to 18 carbon atoms, e.g. from coco-palm-, tallow- or oleyl alcohol, and an average of 2 to 8 EO per mol alcohol. Exemplary preferred ethoxylated alcohols include C₁₂₋₁₄ alcohols with 3 EO or 4EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, as well as mixtures of C₁₂₋₁₄ alcohol with 3 EO and C₁₂₋₁₈ alcohol with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO.

Another class of preferred non-ionic surfactants which are used either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain, more particularly the fatty acid methyl esters which are described, for example, in Japanese patent application JP 58/217598 or which are preferably produced by the process described in International Patent application WO-A-90/13533.

A further class of non-ionic surfactants, which can be advantageously used, are the alkyl polyglycosides (APG). Suitable alkyl polyglycosides satisfy the general Formula RO(G)_{Z} where R is a linear or branched, particularly 2-methyl-branched, saturated or unsaturated aliphatic group containing 8 to 22 and preferably 12 to 18 carbon atoms and G stands for a glycose unit containing 5 or 6 carbon atoms, preferably glucose. There, the degree of glycosidation z is between 1.0 and 4.0 and preferably between 1.0 and 2.0 and particularly between 1.1 and 2.0.

Linear alkyl polyglucosides are preferably employed, that is alkyl polyglycosides, in which the polyglycosyl group is a glucose group and the alkyl group is an n-alkyl group.

The surfactant granulates can preferably comprise alkyl polyglycosides, wherein APG contents above 0.2 wt. % based on the total molded article are preferred. Particularly preferred detergent molded articles comprise APG in amounts of 0.2 to 10 wt. %, preferably in amounts of 0.2 to 5 wt. % and particularly in amounts of 0.5 to 3 wt. %.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (III),

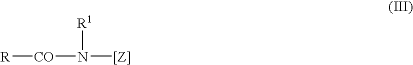

in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfafty acid amides also includes compounds corresponding to the Formula (IV)

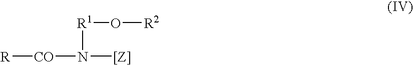

in which R stands for a linear or branched alkyl or alkenyl group containing 7 to 12 carbon atoms, R¹ for a linear, branched or cyclic alkyl group or an aryl group containing 2 to 8 carbon atoms and R² for a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

[Z] is preferably obtained by reductive amination of a reducing sugar, for example glucose, fructose, maltose, lactose, galactose, mannose or xylose. The N-alkoxy- or N-aryloxy-substituted compounds may then be converted, for example according to the teaching of the international application WO-A-95/07331, into the required polyhydroxyfatty acid amides by reaction with fatty acid methyl esters in the presence of an alkoxide as catalyst.

Another significant group of ingredients of detergents and cleaning compositions are the builders. This class of substances is understood to encompass both organic and inorganic builders. These are compounds that can perform both a carrier function in the compositions according to the invention and also act as a water-softening substance in use.

Useful organic builders are, for example, the polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, amino carboxylic acids, nitrilotriacetic acid (NTA), providing such use is not ecologically unsafe, and mixtures thereof. Preferred salts are the salts of polycarboxylic acids such as citric acid, adipic acid, succinic acid, glutaric acid, tartaric acid, sugar acids and mixtures thereof. Acids per se can also be used. Besides their building effect, the acids also typically have the property of an acidifying component and, hence also serve, for example in the granulates according to the invention, to establish a low and mild pH in detergents or cleaning compositions. Citric acid, succinic acid, glutaric acid, adipic acid, gluconic acid and any mixtures thereof are particularly mentioned in this regard.

Other suitable builders are polymeric polycarboxylates, i.e. for example the alkali metal salts of polyacrylic or polymethacrylic acid, for example those with a relative molecular weight of 500 to 70 000 g/mol. This substance class was described in detail further above. The (co)polymeric polycarboxylates can be added either as powders or as aqueous solutions. The (co)polymeric polycarboxylate content of the compositions is preferably from 0.5 to 20% by weight, in particular from 3 to 10% by weight.

In order to improve the water solubility, the polymers can also comprise allylsulfonic acids as monomers, such as for example, allyloxybenzenesulfonic acid and methallylsulfonic acid in EP-B-727448. Biodegradable polymers comprising more than two different monomer units are also particularly preferred, examples being those comprising, as monomers, salts of acrylic acid and of maleic acid, and also vinyl alcohol or vinyl alcohol derivatives, as in DE-A-43 00 772, or those comprising, as monomers, salts of acrylic acid and of 2-alkylallyl sulfonic acid as in DE-C-42 21 381, and also sugar derivatives. Further preferred copolymers are those that are described in the German Patent applications DE-A-43 03 320 and DE-A-44 17 734 and preferably include acrolein and acrylic acid/acrylic acid salts or acrolein and vinyl acetate as monomers. Similarly, other preferred builders are polymeric amino dicarboxylic acids, salts or precursors thereof. Those polyaspartic acids or their salts and derivatives disclosed in the German Patent application DE-A 195 40 086 as having a bleach-stabilizing action in addition to cobuilder properties are particularly preferred.

Further suitable builders are polyacetals that can be obtained by treating dialdehydes with polyol carboxylic acids that possess 5 to 7 carbon atoms and at least 3 hydroxyl groups, as described for example in the European Patent application EP-A-0 280 223. Preferred polyacetals are obtained from dialdehydes like glyoxal, glutaraldehyde, terephthalaldehyde as well as their mixtures and from polycarboxylic acids like gluconic acid and/or glucoheptonic acid.

Further suitable organic builders are dextrins, for example oligomers or polymers of carbohydrates that can be obtained by the partial hydrolysis of starches. The hydrolysis can be carried out using typical processes, for example acidic or enzymatic catalyzed processes. The hydrolysis products preferably have average molecular weights in the range 400 to 500 000 g/mol. A polysaccharide with a dextrose equivalent (DE) of 0.5 to 40 and, more particularly, 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2000 to 30 000 g/mol may be used. A preferred dextrin is described in the British Patent application 94 19 091. The oxidized derivatives of such dextrins concern their reaction products with oxidizing agents that are capable of oxidizing at least one alcohol function of the saccharide ring to the carboxylic acid function. Such oxidized dextrins and processes for their manufacture are known for example from the European Patent applications EP-A 0 232 202, EP-A 0 427 349, EP-A 0 472 042 and EP-A 0 542 496 as well as from the international Patent applications WO 92/18542, WO 93/08251, WO 93/16110, WO 94/28030, WO 95/07303, WO 95/12619 and WO 95/20608. An oxidized oligosaccharide according to the German Patent application DE-A 196 00 018 is also suitable. A product oxidized at C₆ of the saccharide ring can be particularly advantageous.

Oxydisuccinates and other derivatives of disuccinates, preferably ethylenediamine disuccinate are also further suitable cobuilders. Here, ethylenediamine-N,N-disuccinate (EDDS), the synthesis of which is described for example in U.S. Pat. No. 3,158,615, is preferably used in the form of its sodium or magnesium salts. In this context, glycerine disuccinates and glycerine trisuccinates are also particularly preferred, such as those described in the U.S. Pat. No. 4,524,009, U.S. Pat. No. 4,639,325, in the European Patent application EP-A 0 150 930 and in the Japanese Patent application JP 93/339896. Suitable addition quantities in zeolite-containing and/or silicate-containing formulations range from 3 to 15% by weight.

Other useful organic co-builders are, for example, acetylated hydroxycarboxylic acids and salts thereof, which optionally may also be present in lactone form and which contain at least 4 carbon atoms, at least one hydroxyl group and at most two acid groups. Such cobuilders are described, for example, in the international Patent application WO 95/20029.

The phosphonates represent a further class of substances with cobuilder properties. In particular, they are hydroxyalkane phosphonates or aminoalkane phosphonates. Among the hydroxyalkane phosphonates, 1-hydroxyethane-1,1-diphosphonate (HEDP) is of particular importance as the cobuilder. It is normally added as the sodium salt, the disodium salt reacting neutral and the tetrasodium salt reacting alkaline (pH 9). Ethylenediamine tetramethylene phosphonate (EDTMP), diethylenetriamine pentamethylene phosphonate (DTPMP) and their higher homologs are preferably chosen as the aminoalkane phosphonates. They are preferably added in the form of the neutral-reacting sodium salts, e.g. as the hexasodium salt of EDTMP or as the hepta and octasodium salt of DTPMP. Of the class of phosphonates, HEDP is preferably used as the builder. The aminoalkane phosphonates additionally possess a pronounced ability to complex heavy metals. Accordingly, it can be preferred, particularly where the agents also contain bleach, to use aminoalkane phosphonates, particularly DTPMP, or mixtures of the mentioned phosphonates.

In addition, any compounds capable of forming complexes with alkaline earth metal ions may be used as co-builders.

A preferred suitable inorganic builder is fine crystalline, synthetic zeolite containing bound water. Of the suitable fine crystalline, synthetic zeolites containing bound water, zeolite A and/or P are preferred. Zeolite MAP e.g. Doucil A24® (commercial product of the Crossfield company), for example, is employed as the zeolite P. However, Zeolite X and mixtures of A, X and/or P, for example a co crystal of zeolites A and X, the Vegobond® AX (commercial product of Condea Augusta S.p.A.) are also preferred. The zeolite can be employed as the spray-dried powder or also as the non-dried, still moist from its manufacture, stabilized suspension. For the case where the zeolite is added as a suspension, this can comprise small amounts of non-ionic surfactants as stabilizers, for example 1 to 3 wt. %, based on the zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have a mean particle size of less than 10 μm (volume distribution, as measured by the Coulter Counter Method) and contain preferably 18 to 22% by weight and more preferably 20 to 22% by weight of bound water. In preferred embodiments, zeolites are comprised in amounts of 10 to 94.5 wt. % in the premix, wherein it can be particularly preferred if zeolites are comprised in amounts of 20 to 70, particularly 30 to 60 wt. %.

Suitable partial substitutes for zeolites are layered silicates of natural and synthetic origin. These types of layered silicates are known, for example, from the patent applications DE-B-23 34 899, EP-A-0 026 529 and DE-A-35 26 405. Their usability is not limited to a specific composition or structural formula. However, smectites, particularly bentonites are preferred. Suitable crystalline, layered sodium silicates corresponding to the general formula NaMSiₓO₂ₓ₊₁ 7H₂O, wherein M is sodium or hydrogen, x is a number from 1.9 to 4 and y is a number from 0 to 20 and preferred values for x being 2, 3 or 4, are also suitable for substituting zeolites or phosphates. These types of crystalline layered silicates are described, for example, in the European Patent application EP-A-0 164 514. Preferred crystalline layered silicates of the given formula are those in which M stands for sodium and x assumes the values 2 or 3. Both β- and also δ-sodium disilicates Na₂Si₂O₅ yH₂O are particularly preferred.

Preferred builders also include amorphous sodium silicates with a modulus (Na₂O:SiO₂ ratio) of 1:2 to 1:3.3, preferably 1:2 to 1:2.8 and more preferably 1:2 to 1:2.6 which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflexions typical of crystalline substances in X-ray diffraction experiments but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is to be interpreted to mean that the products have microcrystalline regions between 10 and a few hundred nm in size, values of up to at most 50 nm and especially up to at most 20 nm being preferred. This type of X-ray amorphous silicates, which similarly possess a delayed dissolution in comparison with the customary water glasses, are described, for example in the German Patent application DE-A-44 00 024. Compacted amorphous silicates, compounded amorphous silicates and overdried X-ray-amorphous silicates are particularly preferred, the overdried silicates in particular preferably also occurring as carriers in the granules according to the invention or being used as carriers in the process according to the invention.

Naturally, the generally known phosphates can also be added as builders, in so far that their use should not be avoided on ecological grounds. The sodium salts of the orthophosphates, the pyrophosphates and especially the tripolyphosphates are particularly suitable. Their content is generally not more than 25 wt. %, preferably not more than 20 wt. %, each based on the finished composition. In some cases it has been shown that particularly tripolyphosphates, already in low amounts up to maximum 10 wt. %, based on the finished composition, in combination with other builders, lead to a synergistic improvement of the secondary washing power.

Besides the already mentioned ingredients, the inventive detergent and cleaning agent compositions can comprise one or more substances from the group of the bleaching agents, bleach activators, enzymes, pH adjustors, fluorescent agents, foam inhibitors, silicone oils, anti-redeposition agents, optical brighteners, graying inhibitors, color transfer inhibitors, corrosion inhibitors and silver corrosion inhibitors. These substances are described below.

Among the compounds that serve as bleaching agents and liberate H₂O₂ in water, sodium perborate tetrahydrate, sodium perborate monohydrate and sodium percarbonate, are of particular importance. Examples of further bleaching agents that may be used are peroxypyrophosphates, citrate perhydrates and H₂O₂-liberating peracidic salts or peracids, such as perbenzoates, peroxyphthalates, diperoxyazelaic acids, phthaloimino peracids or diperoxydodecanedioic acids. Also, when using bleaching agents, it is possible to forgo the addition of surfactants and/or builders, such that tablets of pure bleaching agent can be manufactured. If bleaching agent tablets of this type are intended for use in textile washing, then a combination of sodium percarbonate with sodium sesquicarbonate is preferred, independently of which additional ingredients are comprised in the tablets. If cleaning or bleaching agent tablets are manufactured for automatic dishwashers, then bleaching agents from the group of the organic bleaching agents may also be employed. Typical organic bleaching agents are the diacyl peroxides, such as e.g. dibenzoyl peroxide. Further typical organic bleaching agents are the peroxy acids, wherein the alkylperoxy acids and the arylperoxy acids may be named as examples. Preferred representatives that can be incorporated are (a) peroxybenzoic acid and ring-substituted derivatives thereof, such as alkyl peroxybenzoic acids, but also peroxy-α-naphthoic acid and magnesium monoperphthalate, (b) aliphatic or substituted aliphatic peroxy acids, such as peroxylauric acid, peroxystearic acid, E-phthalimidoperoxycaproic acid [phthaloiminoperoxyhexanoic acid (PAP)], o-carboxybenzamido peroxycaproic acid, N-nonenylamido peradipic acid and N-nonenylamido persuccinates and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic acid).

Chlorine- or bromine-releasing substances can also be incorporated as bleaching agents in compositions for automatic dishwashers. Suitable chlorine- or bromine-releasing materials include, for example, heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

The detergents and cleaning compositions according to the invention can comprise bleach activators in order to achieve an improved bleaching action for washing or cleaning at temperatures of 60° C. and below. Bleach activators, which can be used, are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or iso-nonanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In addition to, or instead of the conventional bleach activators mentioned above, so-called bleach catalysts may also be incorporated. These substances are bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands, as well as cobalt-, iron-, copper- and ruthenium-ammine complexes may also be employed as the bleach catalysts.

Suitable enzymes are those from the classes of proteases, lipases, amylases, cellulases or mixtures thereof. Enzymatic active materials obtained from bacterial sources or fungi such as bacillus subtilis, bacillus licheniformis and streptomyceus griseus are particularly well suited. Proteases of the subtilisin type and particularly proteases that are obtained from bacillus lentus, are preferably used. Here, mixtures of enzymes are of particular interest, for example protease and amylase or protease and lipase or protease and cellulase or cellulase and lipase or protease, amylase and lipase or protease, lipase and cellulase, in particular, however, cellulase-containing mixtures. Peroxidases or oxidases have also proved to be suitable in certain cases. The enzymes can be adsorbed on carriers and/or embedded in encapsulants, in order to protect them against premature decomposition. The content of the enzymes, enzyme mixtures or enzyme granulates in the inventive molded articles can be, for example, about 0.1 to 5% by weight and is preferably 0.1 to about 2% by weight. The most frequently used enzymes include lipases, amylases, cellulases and proteases. Preferred proteases are for example BLAP® 140 from Biozym Company, Optimase® M-440 and Opticlean® M-250 from Solvay Enzymes; Maxacal® CX and Maxapem® or Esperase® from Gist Brocades or also Savinase® from the Novo Company. Particularly suitable cellulases and lipases are Celluzym® 0.7 T and Lipolase® 30 T from the Novo Nordisk Company. Duramyl® and Termamyl® 60 T, and Termamyl® 90 T from the Novo Company, Amylase-LT® from Solvay Enzymes or Maxamyl® P5000 from Gist Brocades find particular use as amylases. Other enzymes can also be used.

In addition, the detergent and cleaning compositions can also comprise components that positively influence the oil and fat removal from textiles during the wash (so-called soil repellents). This effect is particularly noticeable when a textile is dirty and had been previously already washed several times with an inventive detergent that comprised this oil- or fat-removing component. The preferred oil and fat removing components include, for example, non-ionic cellulose ethers such as methyl cellulose and methyl hydroxypropyl cellulose with a content of methoxy groups of 15 to 30 wt. % and hydroxypropoxy groups of 1 to 15 wt. %, each based on the non-ionic cellulose ether, as well as polymers of phthalic acid and/or terephthalic acid or their derivatives known from the prior art, particularly polymers of ethylene terephthalates and/or polyethylene glycol terephthalates or anionically and/or non-ionically modified derivatives thereof. From these, the sulfonated derivatives of the phthalic acid polymers and the terephthalic acid polymers are particularly preferred.

The agents may comprise derivatives of diaminostilbene disulfonic acid or alkali metal salts thereof as the optical brighteners. Suitable optical brighteners are, for example, salts of 4,4-bis-(2-anilino-4-morpholino-1,3,5-triazinyl-6-amino)stilbene-2,2′-disulfonic acid or compounds of similar structure which contain a diethanolamino group, a methylamino group, an anilino group or a 2-methoxyethylamino group instead of the morpholino group. Brighteners of the substituted diphenylstyryl type may also be present, for example the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the abovementioned brighteners may also be used.

In order to enhance the esthetic impression of the compositions of the invention, they may be colored with appropriate colorants. Preferred colorants, which are not difficult for the expert to choose, have high storage stability, are not affected by the other ingredients of the detergents or by light and do not have any pronounced substantivity for the textile fibers being treated, so as not to color them.

Inventive dishwashing detergents can contain corrosion inhibitors to protect the tableware or the machine, silver protection agents being particularly important in automatic dishwashing. Above all, silver protectors selected from the group of triazoles, benzotriazoles, bisbenzotriazoles, aminotriazoles, alkylaminotriazoles and the transition metal salts or complexes may generally be used. Benzotriazole and/or alkylaminotriazole are particularly preferably used. Moreover, agents containing active chlorine are frequently encountered in cleaning formulations, which can significantly reduce corrosion of the silver surface. In chlorine-free cleaning products, particular use is made of oxygen-containing and nitrogen-containing organic redox-active compounds, such as dihydric and trihydric phenols, e.g. hydroquinone, pyrocatechol, hydroxyhydroquinone, gallic acid, phloroglucinol, pyrogallol and derivatives of these classes of compound. Salts and complexes of inorganic compounds, such as salts of the metals Mn, Ti, Zr, Ht, V, Co and Ce are also frequently used. Preference is given in this context to the transition metal salts selected from the group consisting of manganese and/or cobalt salts and/or complexes, particularly preferably cobalt ammine complexes, cobalt acetato complexes, cobalt carbonyl complexes, the chlorides of cobalt or of manganese, and manganese sulfate. Zinc compounds may also be used to prevent corrosion of tableware.

Particular ingredients which may be used in compositions according to the invention for machine dishwashing or for cleaning hard surfaces are substances that prevent the re-soiling of surfaces and/or facilitate the removal of soil after a single application (“soil release compounds”).

Suitable soil release compounds are any of the compounds known in the prior art. Particularly suitable are cationic polymers such as, for example, hydroxypropyl trimethylammonium guar, copolymers of aminoethyl methacrylate and acrylamide and copolymers of dimethyl diallyl ammonium chloride and acrylamide, polymers containing imino groups, cationic cellulose derivatives, cationic homo- and/or copolymers (monomer units; quaternized ammonium alkyl methacrylate groups).

Particularly preferred soil release compounds are cationic polymers selected from cationic polymers of copolymers of such monomers as trialkyl ammonium alkyl (meth)acrylate or acrylamide; dialkyl diallyl diammonium salts; polymer-analog reaction products of ethers or esters of polysaccharides containing pendant ammonium groups, more particularly guar, cellulose and starch derivatives; polyadducts of ethylene oxide with ammonium groups; quaternary ethylene imine polymers and polyesters and polyamides containing quaternary side groups. Natural polyuronic acids and related substances, polyampholytes and hydrophobicized polyampholytes and mixtures of these substances are also very much preferred in the context of the present application.

This list of ingredients of detergent and cleaning compositions is by no means complete but merely represents the most important typical ingredients of such compositions. Particularly in the case that the preparations are liquid or in gel form, they can also comprise organic solvents. They are preferably mono- or polyhydroxy alcohols containing 1 to 4 carbon atoms Ethanol, 1,2-propanediol, glycerine together with mixtures thereof are preferred alcohols in such compositions. In preferred embodiments, such compositions comprise 2 to 12 wt. % of such alcohols.

Fundamentally, the compositions may assume various aggregate states. In a preferred embodiment, the detergent or cleaning compositions are liquid or gel-form compositions, more particularly liquid detergents or liquid dishwashing detergents or cleaning gels including in particular gel-form cleaners for flush toilets.

These types of gel-form cleaners for flush toilets are described, for example, in German patent application DE 197 158 72. These cleaners are preferably gel-form, pseudoplastic cleaners with a viscosity of 30 000 to 150 000 mPas which contain a polysaccharide as the gel-forming component, a C₈-C₁₀ alkyl polyglycoside or C₁₂-C₁₄ alkyl polyglycoside as emulsifier and wetting component and perfume oil. Fatty alcohol ether sulfates (FAEOS) and fatty alcohol sulfates (FAS) may be comprised as additional co-surfactants. The APG/co-surfactant ratio is generally greater than 1, preferably between 50:1 and 1:1, more preferably between 10:1 and 1.5:1 and most preferably between 5:1 and 1.8:1. The cleaners in question are, more particularly, stable, gel-form, shear-diluting cleaners comprising polysaccharide, a surfactant system and perfume components, characterized in that they contain

a polysaccharide, preferably a xanthan gum, in quantities between 1 and 5% by weight, preferably 1 to 4% by weight, more preferably 1.5 to 3.5% by weight and most preferably 1.8 to 3% by weight,

a C₈-C₂₂ alkyl polyglycoside as one component of the surfactant system in quantities between 3 and 25% by weight, preferably 4 and 20% by weight, more preferably 5 and 15% by weight and most preferably 5 and 12% by weight and

the perfume component(s) in quantities of up to 15% by weight, preferably 2 to 12% by weight and more preferably 3 to 8% by weight

and optionally other ingredients, such as lime-dissolving agents, dyes, germ inhibitors, pearlizers, stabilizers, cleaning boosters and odor absorbers,

and the compositions have a viscosity of 30 000 to 150 000 mPas, as measured with a Brookfield Helipath RVT rotational viscosimeter with a TA spindle at 1 r.p.m. and 23° C.

Cleaning gels of this type are normally dosed in containers that are designed to be placed in a lavatory bowl or in cisterns. A special container, which is particularly suitable for the gel-form cleaning compositions, is described in German patent application DE 195 201 45.

It has been found that visually attractive, translucent or clear pseudoplastic gel structures, which are as stable in suitable containers as the solid rim blocks, can be obtained with polysaccharides in the described combinations, depending on the types selected with high perfume and APG concentrations.

Other standard gel formers such as, for example, polyacrylic acid (Carbopol), surfactant-thickened systems, MHPC (Natrosol) or sodium chloride- or electrolyte-thickened surfactant systems do not show the required gel stability where the required high surfactant and perfume levels are used and accordingly are less preferred. These formulations are often not sufficiently pseudoplastic, are diluted by water flowing over them and, on account of their inadequate viscosity behavior, drip uncontrollably into the lavatory bowl despite suitable containers. In contrast, the preferred formulations are decidedly pseudoplastic and thus withstand the water flowing over them to the extent that only small amounts are released and the required stability is obtained. This is because the compositions should also not dissolve too readily in the water penetrating into their containers, otherwise they would already dissolve and therefore be used up after only a small number of flushes.

In this connection it is particularly preferred that under certain conditions in the production process, air bubbles are introduced into the compositions and retain their shape and size over a period of several weeks such that the end product becomes even more visually attractive to the consumer.

The size of the air bubbles, which can be controlled for example through the stirring rate in the production process and through the viscosity of the compositions, should be neither too large nor too small, and the amount of air bubbles should likewise be chosen to be only in a preferred range. If, therefore, the presence of air bubbles were desired, then no more than 30% volume of air should be present, air volumes of 2 to 25% by volume being preferred and air volumes of 5 to 20% by volume being particularly preferred. Quite particularly preferred embodiments comprise air bubbles between 0.1 mm and 20 mm in diameter, air bubbles between 1 mm and 15 mm diameter being most particularly preferred. However, the viscosity of the preferred compositions also enables the air bubbles already introduced in the production process to be removed by brief application of a reduced pressure that can be in a range just below ambient pressure to approaching a vacuum. The duration of the reduced pressure treatment will depend on the magnitude of the reduced pressure. If a relatively strong reduced pressure is applied, the treatment need not be continued for very long. However, the person skilled in the art also knows that an excessive reduced pressure can result in unwanted side effects including, for example, the intensified evaporation of readily volatile perfume components and, in some cases, problems affecting the ability to stir the system. Although the compositions according to the invention can be degassed by treatment in a centrifuge or by ultra rapid stirring, such treatments are less preferred.

The formulations may be produced in various ways and in various batch sizes up to, and including, several tonnes. Normally, water is introduced into a commercially available mixer, for example a Beco-Mix, and the dye is stirred in. The xanthan gum used is separately suspended with solvent, preferably ethanol, and the required perfume oil. The suspension is then added and the whole is stirred at low speed, for example at 30 rpm.

Investigations have shown that, after all the components have been added, a time of a few minutes to a few hours is required to reach the consistency according to the invention. In the present case, the surfactant (alkyl polyglycoside) was slowly metered in after 30 minutes. The other components are then added.

If a bubble-free gel is to be guaranteed, the mixture, as a function of its viscosity, has to be placed under a reduced pressure or under a vacuum, as described above, in a suitable container, but generally for a short time, for example 15 minutes.

However, the person skilled in the art may adopt other procedures. This is advisable, for example, where disinfectants are to be incorporated. In this case, water is normally introduced into a commercially available mixer, for example a Beco-Mix, and the xanthan gum used is then stirred in. The suspension is then added and the whole is stirred at low speed, for example at 30 rpm, before the surfactant mixture (alkyl polyglycoside/fatty alcohol ether sulfate) is slowly metered in after 30 minutes. The dye is then added prior to the addition of an ethanolic solution of the perfume.

The disinfectant, preferably selected from the group of the isothiazolines, the benzoates or the salicylic acid or salicylates, is added next.

In this case, the composition can be packed in commercially available measuring bottles, for example in a rotary bottle-filling machine.

Particular care has to be taken when substances are added to the prepared and swollen aqueous xanthan gel to allow the structure according to the invention to form. If these substances are added too quickly, problems of phase separation can arise. In addition, no surfactant should be present during the preparation of the xanthan gel component because it would prevent gel formation. Accordingly, it is very much preferred to add the surfactant components after formation of the gel.

The viscosity may be measured by any of the methods normally used.

Brookfield viscosimeters which have a spindle specially designed for gels were used in the present case. The viscosities according to the invention were measured with this Helipath spindle.

In a representative formulation, the preferred gel formulations can comprise the following components;

1.0-5.0 wt. % polysaccharide
3.0-25.0 wt. % C₈-C₂₂ alkyl polyglycoside
0-15.0 wt. % co-surfactants (FAS, FAEOS)
0-5.0 wt. % citric acid
0-5.0 wt. % complexing agent
up to 15 wt. % preferably 2.0-12.0 wt. % perfume
up to 5.0 wt. % preferably 0.01 to 4 wt. % solvent, such as e.g. ethanol
0-1.0 wt. % preservative
0-10.0 wt. % dye
0-5.0 wt. % preferably 0.01 to 3 wt. % germ inhibitor

In the context of the present invention, a xanthan gum or a guar gum or a mixture of polysaccharides are understood, for example, to be a polysaccharide.

Xanthane is formed from a chain of linked β-1,4-glucose (cellulose) with side chains. The structure of the sub-groups consists of glucose, mannose, glucuronic acid, acetate and pyruvate. Xanthan is produced with a molecular weight of 2-15×10⁶ by Xanthonomas campestris under aerobic conditions. Xanthan is produced inter alia in batch cultures and, after destruction of the culture and precipitation with propanol, is dried and ground. Other suitable methods are also described in the literature.

Alkyl polyglycosides are the above-cited surfactants that can be obtained by the reaction of sugars and alcohols using appropriate methods of preparative organic chemistry, whereby a mixture of monoalkylated, oligomeric or polymeric sugars is obtained, depending on the method of preparation. Preferred alkyl polyglycosides are alkyl polyglucosides, in which particularly preferably, the alcohol is a long-chain fatty alcohol with alkyl chain lengths of C₈ to C₂₂, preferably from C₈ to C16 and more preferably from C₈ to C₁₂ or a mixture of long-chain fatty alcohols. The degree of oligomerization of the sugars, which is a calculated quantity, i.e. is generally not a whole number, is between 1 and 10, preferably between 1.1 and 5, quite particularly preferably between 1.2 and 3 and most preferably between 1.3 and 2.5.

According to the present invention, anionic co-surfactants can be aliphatic sulfates, such as fatty alcohol sulfates, fatty alcohol ether sulfates, dialkyl ether sulfates, monoglyceride sulfates, and aliphatic sulfonates, such as alkane sulfonates, olefin sulfonates, ether sulfonates, n-alkyl ether sulfonates, ester sulfonates and lignin sulfonates. Other anionic co-surfactants which may be used in the context of the present invention, but are not preferred, are fatty acid cyanamides, sulfosuccinic acid esters, fatty acid isethionates, acylaminoalkane sulfonates (fatty acid taurides), fatty acid sarcosinates, ether carboxylic acids and alkyl (ether) phosphates. Fatty alcohol sulfates and fatty alcohol ether sulfates are preferably used. Hitherto, less favorable results were obtained with alkyl benzenesulfonates.

However, non-ionic co-surfactants may also be used. Non-ionic surfactants in the context of the present invention include alkoxylated alcohols, such as polyglycol ethers, fatty alcohol polyglycol ethers, alkylphenol polyglycol ethers, end-capped polyglycol ethers, mixed ethers and hydroxy mixed ethers and fatty acid polyglycol esters. Ethylene oxide, propylene oxide, block polymers and fatty acid alkanolamides and fatty acid polyglycol ethers may also be used.

Alkoxylated alcohols are generally understood by the person skilled in the art to be the reaction products of alkylene oxide, preferably ethylene oxide, with alcohols, preferably relatively long-chain alcohols. As a rule, n moles of ethylene oxide react with one mole of alcohol to form, depending on the reaction conditions, a complex mixture of addition products with different degrees of ethoxylation. A further embodiment consists in the use of mixtures of alkylene oxides, preferably the mixture of ethylene oxide and propylene oxide. If desired, the substance class of end-blocked (“capped”) can be produced by a subsequent etherification with short chain alkyl groups, preferably the butyl group, and can also be used in the context of the invention. In the context of the present invention, highly ethoxylated fatty alcohols or their mixtures with end-blocked ethoxylated fatty alcohols are quite particularly preferred.

The formulations may advantageously comprise lime-dissolving acids, such as citric acid, acetic acid, lactic acid or water-soluble salts thereof in a quantity of 1 to 12 wt. %. Contents of between 2 and 5 wt. % are particularly preferred.

The gels preferably comprise dye, either for coloring the product or for coloring the liquid circulating around the container. Preferably, the content of water-soluble dyes is below 1% by weight and is intended to improve the visual appearance of the product. If an additional color signal is required during flushing, the content of water-soluble dyes may be increased to 5% by weight.

Although the gels already have an excellent cleaning effect without this component, the hygienic effect can be enhanced by the addition of germ inhibitors. The quantity of germ inhibitor used is governed to a large extent by the effectiveness of the particular compound and may be as much as 5% by weight. A quantity of more than 0.01% by weight is preferably incorporated in the gels. Quantities of 0.01% by weight to 3% by weight are particularly preferred. Isothiazoline mixtures, sodium benzoate or salicylic acid are particularly suitable.

The perfume oils, which may be present in preferred gels in quantities of up to 15% by weight, particularly 2 to 12% by weight and quite particularly preferably from 3 to 8% by weight, include the compounds already described in the foregoing. According to the invention, these perfume oils contain the inventive silicon compounds. The perfume oil may consist entirely of such silicon compounds or may even comprise these silicon compounds in mixtures with other fragrances.

Suitable solubilizers, for example for dyes and perfume oils, include for example alkanolamines, polyols, such as ethylene glycol, propylene glycol, glycerol and other monohydric and polyhydric alcohols and also alkyl benzenesulfonates with 1 to 3 carbon atoms in the alkyl moiety. The group of lower alcohols is particularly preferred, ethanol being quite particularly preferred.

Conventional thickeners, which could also be used if required, include urea, sodium chloride, sodium sulfate, magnesium sulfate, ammonium chloride and magnesium chloride and combinations thereof. However, the use of these additional thickeners is not preferred.

The gels according to the invention may optionally contain water-soluble and water-insoluble builders. Water-soluble builders are preferred because they are generally not as prone to form insoluble residues on hard surfaces. Conventional builders which may be present in accordance with the invention include low molecular weight polycarboxylic acids and salts thereof, the homopolymeric and copolymeric polycarboxylic acids and salts thereof, citric acid and salts thereof, carbonates, phosphates and silicates. Water-insoluble builders include zeolites, which may also be used, and mixtures of the builders mentioned above. The group of citrates is particularly preferred.

Other typical cleaners, which may comprise the silicon compounds according to the invention, are liquid or gel-form cleaners for hard surfaces, in particular so-called multipurpose cleaners, glass cleaners, floor and bathroom cleaners and special embodiments of such cleaners, including acidic and alkaline forms of multipurpose cleaners and glass cleaners with a so-called anti-rain effect. These liquid cleaners may be present in one or also in a plurality of phases. In a particularly preferred embodiment, the cleaners have two different phases.

Cleaners in the broadest sense are generally surfactant-containing formulations with a very wide range of uses and, dependent thereon, very different compositions. The most important market segments are domestic cleaners, industrial (technical) and institutional cleaners. Cleaners are divided into alkaline, neutral and acidic types according to their pH, and into liquid and solid cleaners (including tablets) according to their supply form. In contrast for example to dishwashing detergents, which also belong to the product group of cleaners, so-called hard surface cleaners are intended to show an optimal performance profile both in concentrated form and after dilution with water in conjunction with mechanical energy. Cold cleaners develop their effect without elevated temperature. The cleaning effect is critically determined inter alia by surfactants and/or alkalinity sources or acids and, optionally, even solvents, such as glycol ethers and lower alcohols. In general, the formulations also contain builders and, depending on the type of cleaner, also bleaching agents, enzymes, germ-reducing or disinfecting additives and perfume oils and dyes. Cleaners may also be formulated as microemulsions. The cleaning result depends to a large extent on the type of soiling, which is also geographically very different, and on the properties of the surfaces to be cleaned.

Household cleaners may be formulated as universal cleaners or as special cleaners for inter alia ceramics, tiles, windows, plastics, (carpets) flooring, cookers, ovens, microwave ovens, as sanitary cleaners or lavatory cleaners. Pipe cleaners are alkaline and consist, for example, of solid sodium hydroxide and aluminium powder that, on dissolving, provides the hydrogen for creating the necessary turbulence in the pipe segments to be unblocked. Besides surfactant and builder, sanitary cleaners contain inter alia germ-reducing active ingredients, the sodium hypochlorite previously used being partly replaced by hydrogen peroxide or other peroxygen compounds. Lavatory cleaners are mainly acidic, occasionally even alkaline, wherein in the former case, the phosphoric acid originally used and the sodium hydrogen sulfate are largely replaced by organic acids, inter alia citric acid. Specialty cleaners in the DIY sector include car cleaners, windscreen cleaners, rim cleaners, engine cleaners and paint applicator cleaners.

Institutional cleaners are used for operational cleaning and hygiene, for example in schools, offices, hotels, guesthouses and hospitals. In the last case, safe surface disinfection is a particular requirement that the products are expected to satisfy. Institutional cleaners are available in large containers (large consumer products). The products and associated services using specially developed cleaning equipment are marketed as system solutions. Industrial cleaners are used inter alia in the beverage, food, cosmetic and pharmaceutical industries and also in the metal industry for degreasing. The product group also includes cleaners for car washes, tanker and aircraft cleaners. In view of the necessary productivity, for example in bottle washing, these cleaners have to be formulated with low-foam surfactants, for which purpose special nonionic surfactants, such as ethylene, oxide/propylene oxide block copolymers and so-called end-capped alkyl ethoxylates are suitable.

A preferred multiphase multipurpose cleaner is an aqueous, liquid, multiphase, surfactant-containing cleaner with at least two continuous phases which comprises at least one lower aqueous phase I and an upper aqueous phase II immiscible with phase I, which can be temporarily converted into an emulsion by shaking and which contains 0 to 5% by weight of sodium hexametaphosphate. Sodium hexametaphosphate is a mixture of condensed orthophosphates of Formula I, wherein n stands for an average value of about 12.

One such cleaner is described in the prior German patent application DE 198 11 386. According to the invention, this cleaner comprises fragrances, wherein at least a part of the comprised perfume oils are in the form of the silicon compounds according to the invention.

In the simplest case, the cleaner in question consists of a lower continuous phase that consists of the entire phase I and an upper continuous phase that consists of the entire phase II. However, one or more continuous phases of the composition may also contain parts of another phase in emulsified form, such that in a cleaner such as this part of phase I for example is present as the continuous phase I, which represents the lower continuous phase of the composition, while another part is emulsified as the discontinuous phase I in the upper continuous phase II. The same applies to phase II and other continuous phases.

In this context, temporary is understood to mean that 90% of the separation into the separate phases of the emulsion that was formed by shaking takes place over a period of 2 minutes to 10 hours at temperatures of about 20° C. to about 40° C., and the last 2% of the separation into the phase state before shaking takes place over another 15 minutes to 50 hours.

These types of cleaner are distinguished by an unusually high cleaning performance in undiluted form towards obstinate fatty soils. In addition, they show a favorable residue behavior. The individual phases in the cleaner remain stable for long periods without forming deposits, for example, and the conversion into a temporary emulsion remains reversible even after frequent shaking. In addition, the separation of ingredients into separate phases can promote the chemical stability of the cleaner.

In one preferred embodiment of the invention, the continuous phases I and II are separated from one another by a clearly defined phase boundary.

In another preferred embodiment, one or both of the continuous phases I and II comprise(s) parts, preferably 0.1 to 25% by volume and more preferably 0.2 to 15% by volume, based on the volume of the particular continuous phase, of the other phase as the dispersant. In this way, the continuous phase I or II is reduced by that part by volume which is distributed as the dispersant in the other phase. Particularly preferred compositions are those in which phase I is emulsified into phase II in quantities of 0.1 to 25% by volume and preferably in quantities of 0.2 to 15% by volume, based on the volume of phase II.

In another preferred embodiment of the invention, a part of the two phases in addition to the continuous phases I and II, is present as an emulsion of one of the two phases in the other phase, this emulsion being separated from those parts of phases I and II which are not involved in the emulsion by two clearly defined phase boundaries, namely an upper and a lower phase boundary.

In this connection in a particularly advantageous embodiment, the compositions comprise one or a plurality of hydrophobic components. Suitable hydrophobic components are, for example, dialkyl ethers with identical or different C₄-C₁₄ alkyl groups, more particularly dioctyl ether; hydrocarbons with a boiling range of 100 to 300° C., more particularly 140 to 280° C., for example aliphatic hydrocarbons with a boiling range of 145 to 200° C., isoparaffins with a boiling range of 200 to 260° C.; essential oils, more particularly limonene and the pine oil extracted from pine roots and stumps, and also mixtures of these hydrophobic components, more particularly mixtures of two or three of the hydrophobic components mentioned. Preferred mixtures of hydrophobic components are mixtures of various dialkyl ethers, of dialkyl ethers and hydrocarbons, of dialkyl ethers and essential oils, of hydrocarbons and essential oils, of dialkyl ethers and hydrocarbons and essential oils and mixtures of these. The cleaners comprise hydrophobic components in quantities, based on the composition, of 0 to 20% by weight, preferably 0.1 to 14% by weight, more preferably 0.5 to 10% by weight, most preferably 0.8 to 7% by weight.

The cleaners may moreover contain one or more phase separation auxiliaries. Suitable phase separation auxiliaries are, for example, alkali metal and alkaline earth metal chlorides and sulfates, more especially sodium and potassium chloride and sulfate, and ammonium chloride and ammonium sulfate and mixtures thereof. The cited salts, as strong electrolytes, assist phase separation through the salt effect. Builder salts, as electrolytes, have the same effect and accordingly are also suitable as phase separation auxiliaries. The cleaners comprise phase separation auxiliaries in quantities, based on the composition, of 0 to 30% by weight, preferably 1 to 20% by weight, more preferably 3 to 15% by weight and most preferably 5 to 12% by weight.

The cleaners may contain anionic, non-ionic, amphoteric or cationic surfactants or surfactant mixtures of one, several or all of these surfactant classes as their surfactant component. The cleaners contain surfactants in quantities, based on the composition, of 0.01 to 30% by weight, preferably 0.1 to 20% by weight, more preferably 1 to 14% by weight and most preferably 3 to 10% by weight.

Suitable non-ionic surfactants in the multipurpose cleaners are, for example, C₈-C₁₈ alkyl alcohol polyglycol ethers, alkyl polyglycosides and nitrogen-containing surfactants or mixtures thereof, more especially mixtures of the first two. The cleaners contain non-ionic surfactants in quantities, based on the composition, of 0 to 30% by weight, preferably 0.1 to 20% by weight, more preferably 0.5 to 14% by weight and most preferably 1 to 10% by weight.

C₈-C₁₈ alkyl alcohol polypropylene glycol/polyethylene glycol ethers are preferred known non-ionic surfactants. They may be described by the formula RO—(CH₂CH(CH₃)O)ₚ(CH₂CH₂O)ₑ—H, in which R¹ is a linear or branched, aliphatic alkyl and/or alkenyl group containing 8 to 18 carbon atoms, p stands for 0 or a number from 1 to 3 and e for a number from 1 to 20. The C₈-C₁₈ alkyl alcohol polyglycol ethers may be obtained by addition of propylene oxide and/or ethylene oxide onto alkyl alcohols, preferably onto fatty alcohols. Typical examples are polyglycol ethers in which R¹ is an alkyl group containing 8 to 18 carbon atoms, p=0 to 2 and e is a number from 2 to 7. Preferred representatives are, for example C₁₀-C₁₄ fatty alcohol +1PO+6EO ether (p=1, e=6) and C₁₂-C₁₈ fatty alcohol +7EO ether (p=0, e=7) and mixtures thereof.

End-capped C₈-C₁₈ alkyl alcohol polyglycol ethers, i.e. compounds in which the free OH group in Formula II is etherified, may also be used. The end-capped C₈-C₁₈ alkyl alcohol polyglycol ethers may be obtained by relevant methods of preparative organic chemistry. Preferably, C₈-C₁₈ alkyl alcohol polyglycol ethers are reacted with alkyl halides, more especially butyl or benzyl chloride, in the presence of bases. Typical examples are mixed ethers in which R¹ is a technical fatty alcohol moiety, preferably a C_{12/14} cocoalkyl moiety, p=0 and e=5 to 10, which are end-capped with a butyl group.

Other preferred non-ionic surfactants are again the alkyl polyglycosides described above.

Nitrogen-containing surfactants can be comprised as further surfactants, e.g. fatty acid polyhydroxyamides, for example glucamides, and ethoxylates of alkylamines, vicinal diols and/or carboxylic acid amides, which possess alkyl groups containing 10 to 22 carbon atoms, preferably 12 to 18 carbon atoms. The degree of ethoxylation of these compounds is generally between 1 and 20 and preferably between 3 and 10. Ethanolamide derivatives of alkanoic acids containing 8 to 22 carbon atoms and preferably 12 to 16 carbon atoms are preferred. Particularly suitable compounds include the monoethanolamides of lauric acid, myristic acid and paimitic acid.

Anionic surfactants suitable for multipurpose cleaners are C₈-C₁₈ alkyl sulfates, C₈-C₁₈ alkyl ether sulfates, i.e. the sulfation products of alcohol ethers, and/or C₈-C₁₈ alkyl benzenesulfonates and also C₈-C₁₈ alkanesulfonates, C₈-C₁₈ α-olefin sulfonates, sulfonated C₈-C₁₈ fatty acids, more particularly dodecyl benzenesulfonate, C₈-C₂₂ carboxylic acid amide ether sulfates, sulfosuccinic acid mono- and di-C₁-C₁₂ alkyl esters, C₈-C₁₈ alkyl polyglycol ether carboxylates, C₈-C₁₈ N-acyl taurides, C₈-C₁₈ N-sarconsinates and C₈-C₁₈ alkyl isethionates and mixtures thereof. The anionic surfactants are used in the form of their alkali metal and alkaline earth metal salts, more especially sodium, potassium and magnesium salts, their ammonium and mono-, di-, tri- or tetraalkyl ammonium salts and, in the case of the sulfonates, also in the form of the corresponding acid, for example dodecylbenzene sulfonic acid. The cleaners contain anionic surfactants in quantities, based on the composition, of 0 to 30% by weight, preferably 0.1 to 20% by weight, more preferably 1 to 14% by weight and most preferably 2 to 10% by weight.

Due to their foam-suppressing properties, the multi-purpose cleaners may also contain soaps, i.e. alkali metal or ammonium salts of saturated or unsaturated C₆-C₂₂ fatty acids. The soaps may be used in a quantity of up to 5% by weight, preferably in a quantity of 0.1 to 2% by weight.

Suitable amphoteric surfactants are for example betaines of the Formula (R″X′″R^{IV})N⁺CH₂COO⁻, in which R^{II} means an alkyl group with 8 to 25, preferably 10 to 21 carbon atoms, optionally interrupted by heteroatoms or heteroatomic groups, and R^{III} and R^{IV} mean the same or different alkyl groups with 1 to 3 carbon atoms, in particular C₁₀-C₁₈ alkyldimethylcarboxymethyl betaine and C₁₁-C₁₇ alkylamidopropyldimethylcarboxymethyl betaine. The cleaners comprise amphoteric surfactants in quantities, based on the composition, of 0 to 15% by weight, preferably 0.01 to 10% by weight, particularly 0.1 to 5% by weight.

Suitable cationic surfactants are inter alia the quaternary ammonium compounds of the Formula (R^{V})(R^{VI})(R^{VII})(R^{VIII})N⁺X⁻, in which R^{V} to R^{VIII} stand for four identical or different types, in particular two long and two short chain alkyl groups and X⁻ for an anion, especially a halide ion, for example dodecyl-dimethyl-ammonium chloride, alkyl-benzyl-didecyl-ammonium chloride and their mixtures. The cleaners comprise cationic surfactants in quantities, based on the composition, of 0 to 10% by weight, preferably 0.01 to 5% by weight, particularly 0.1 to 3% by weight.

In a preferred embodiment, the cleaners comprise anionic and non-ionic surfactants together, preferably C₈-C₁₈ lkyl benzenesulfonates, C₈-C₁₈ alkyl sulfates and/or C₈-C₁₈ alkyl ether sulfates in conjunction with C₈-C₁₈ alkyl alcohol polyglycol ethers and/or alkyl polyglycosides, more particularly C₈-C₁₈ alkyl benzenesulfonates together with C₈-C₁₈ alkyl alcohol polyglycol ethers.

In addition, the inventive compositions can comprise builders. Suitable builders are, for example, alkali metal gluconates, citrates, nitrilotriacetates, carbonates and bicarbonates, especially sodium gluconate, citrate and nitrilotriacetate and sodium and potassium carbonate and bicarbonate, and alkali metal and alkaline earth metal hydroxides, especially sodium and potassium hydroxide, ammonia and amines, especially mono- and triethanolamine, and mixtures thereof. Other suitable builders are the salts of glutaric acid, succinic acid, adipic acid, tartaric acid and benzenehexacarboxylic acid and also phosphonates and phosphates. The cleaners comprise builders in quantities, based on the composition, of 0 to 20% by weight, preferably 0.01 to 12% by weight, more preferably 0.1 to 8% by weight and most preferably 0.3 to 5% by weight, the quantity of sodium hexametaphosphate being limited to 0 to 5% by weight except in the cleaners used in accordance with the invention. As electrolytes, the builder salts also act as phase separation auxiliaries.

Besides the cited components, the compositions according to the invention may contain additional auxiliaries and additives of the type typically present in such compositions. These include in particular polymers, soil release agents, solvents (for example ethanol, isopropanol, glycol ether), solubilizers, hydrotropes (for example cumenesulfonate, octyl sulfate, butyl glucoside, butyl glycol), cleaning boosters, viscosity adjusters (for example synthetic polymers, such as polysaccharides, polyacrylates, naturally occurring polymers and derivatives thereof such as xanthan gum, other polysaccharides and/or gelatine), pH adjusters (for example citric acid, alkanolamines or NaOH), disinfectants, antistatic agents, preservatives, bleaching systems, enzymes, dyes and also opacifiers or even skin care agents as described in EP-A 0 522 556. The amount of such additives in the cleaning composition is normally not more than 12% by weight. The lower limit depends upon the nature of the auxiliary/additive and, in the case of dyes for example, may be up tp 0.001% by weight or lower. The auxiliaries/additives are preferably present in a quantity of 0.01 to 7% by weight and particularly 0.1 to 4% by weight.

The pH of the multipurpose cleaners can be varied over a broad range but is preferably in the range 2.5 to 12, particularly 5 to 10.5.

These types of multipurpose cleaner can be modified for any purpose. Glass cleaners are one particular embodiment. A key aspect of glass cleaners is that spots or rings should not be left behind. A particular problem is that, after cleaning, water condenses on the cleaned surfaces and leads to the so-called misting effect. It is equally undesirable for so-called rain marks to be left behind on glass surfaces exposed to rain. This effect is known as the rain effect or anti-rain effect. Suitable additives in glass cleaners can prevent these effects.

WO 96/04358 describes cleaning compositions that are capable of cleaning glass without leaving behind any troublesome stains and/or films and which contain an effective quantity of a substantive polymer containing hydrophilic groups which provides the glass with relatively high and long-lasting hydrophilic properties, such that, for at least the next three times the glass is welted, for example by rain, the water runs off the glass surface and fewer stains are left behind after drying. Substantive polymers are, in particular, polycarboxylates, such as poly(vinyl pyrrolidone-co-acrylic acid), but also poly(styrene sulfonate), cationic sugar and starch derivatives and block copolymers of ethylene oxide and propylene oxide, the latter polyethers in particular having less substantivity.

Epoxy-end-capped polyalkoxylated alcohols corresponding to Formula A are known from WO 94/22800,

R′O[CH₂CH(CH)₃O]ₓ[CH₂CH₂O]_{y}[CH₂CH(R″′)O]_{z}H (A)

in which
R′ is a linear aliphatic hydrocarbon group containing about 4 to about 18 carbon atoms or a mixture of various such groups,
R″ is a linear aliphatic hydrocarbon group containing about 2 to about 26 carbon atoms or a mixture of various such groups,
x is a number from 1 to about 3
y is a number from 5 to about 30 and
z is a number from 1 to about 3.

The alcohols corresponding to Formula A may be incorporated in powdered and liquid dishwasher detergents or cleaning compositions for hard surfaces. In dishwasher detergents, they reduce the formation of spots and films.

Epoxy-end-capped polyalkoxylated alcohols corresponding to Formula B are known from WO 96/12001,

R′″O[CH₂CH(CH)₃O]ᵤ[CH₂CH(R^{iv})O]ᵥ[CH₂CH(R^{v})O]_{w}H (B)

in which
R′″ is a linear aliphatic hydrocarbon group containing about 4 to about 18 carbon atoms or a mixture of various such groups,
R^{iv} stands for a hydrogen atom or a lower alkyl group containing 1 to 6 carbon atoms,
R^{v} is a linear aliphatic hydrocarbon group containing about 2 to about 14 carbon atoms or a mixture of various such groups,
u is a number from 1 to about 5,
v is a number from 1 to about 30 and
w is a number from 1 to about 3.

The alcohols corresponding to Formula B, alone or together with alcohols of Formula A, may be incorporated in powdered and liquid dishwasher detergents or cleaning compositions for hard surfaces like bathroom tiles. In dishwasher detergents, they also reduce the formation of spots and films.

In one particular embodiment, the end-capped polyalkoxylated alcohols of Formula V, described in DE-A-198 56 529,

R¹O[CH₂CH(CH)₃O]ₚ[CH₂CH(R²)O]_{q}R³ (V)

in which
R¹ is a linear aliphatic hydrocarbon group containing 1 to about 22 carbon atoms or a mixture of various such groups,
R² stands for a hydrogen atom or a lower alkyl group containing 1 to 6 carbon atoms,
R³ is a linear or branched, saturated or unsaturated, aliphatic, optionally aryl-substituted, acyclic or cyclic hydrocarbon group containing 1 to about 78 carbon atoms and optionally one or more hydroxyl groups and/or ether groups —O— or a mixture of various such groups,
p is a number from 0 to about 15 and
q is a number from 0 to about 50 and
the sum of p and q is at least 1,
   are incorporated in a composition for cleaning hard surfaces to reduce the rain effect and/or the misting effect.

The content of one or more end capped polyalkoxylated alcohols of Formula I in the glass cleaner is 0.001 to 20 wt. %, preferably 0.01 to 10 wt. %, particularly 0.05 to 5 wt. %, particularly preferably 0.1 to 2.5 wt. % and most preferably 0.2 to 2.0 wt. %.

Exemplary end capped polyalkoxylated alcohols are those of Formula I, in which (a) R¹═C₁₂₋₁₈ or C₁₂₋₁₄ fatty alkyl group, R²═H, R³=butyl group p=0, q=10, (b) R¹═C₁₂₋₁₈ fatty alkyl group, R²═H, R³=butyl group, p=0, q=5, (c) R¹═CH₃, R²═H, R³═C_{12/14} fatty alkyl group, p=3, q=5 or (d) R¹═C₈ fatty alkyl group, R²═H, R³=butyl group, p=0, q=5.

Preferred end-capped polyalkoxylated alcohols are those corresponding to Formula I, in which p and q are both at least 1 and/or R² is a hydrogen atom and/or R³ comprises at least one hydroxyl group, more particularly in the ω-position, i.e. R³ represents a group —CH₂CH(OH)—R. End-capped polyalkoxylated alcohols corresponding to Formula I, in which R³ is a group —CH₂CH(OH)—R, are known for example from DE 37 23 323 A1.

Particularly preferred end-capped polyalkoxylated alcohols are epoxy-end-capped polyalkoxylated alcohols corresponding to Formula I, in which R¹ is a linear aliphatic hydrocarbon group containing about 4 to about 18 and preferably about 4 to about 12 carbon atoms, more particularly a butyl, hexyl, octyl or decyl group or mixtures thereof, or a mixture of various such groups, R² is a hydrogen atom or a lower alkyl group containing 1 to 6 carbon atoms, preferably a hydrogen atom, R³ is a group [CH₂CH(R⁴)O]ᵣH, where R⁴ is a linear aliphatic hydrocarbon group containing about 2 to about 26, preferably about 4 to about 18 and more preferably about 6 to about 14 carbon atoms or a mixture of various such groups and r is a number from 1 to about 3, preferably 1 to about 2, more preferably 1, p is a number from 1 to about 5, preferably 1 to about 2 and more preferably 1 and q is a number from 1 to about 30, preferably about 4 to about 26 and more preferably about 10 to about 24, for example with R¹═C_{8/10} alkyl group, R²═H, R³═[CH₂CH(R⁴)O]ᵣH with R⁴═C₈ alkyl group and r=1, u=1 and v=22.

Such epoxy-end-capped polyalkoxylated alcohols and methods for their manufacture are known, for example, from WO 94/22800 and WO 96/12001. Preferred end-capped alcohols are obtainable, for example, under the trade name Dehypon® from Henkel KGaA or under the trade name Poly Tergent® from Olin Corporation, for example Dehypon® LT 104, Dehypon® LS 104, Dehypon® LT 54, Dehypon® LS 531 or Dehypon® O 54 and Poly Tergent® SLF 18 B48, Poly Tergent® SLF 18 B 45 or Poly Tergent® SL 62.

In another preferred embodiment, the compositions are powder-form or granular compositions. The inventive compositions can have any bulk density. The range of the possible bulk densities goes from low bulk densities below 600 g/l, for example 300 g/l, through medium bulk densities of 600 to 750 g/l to high bulk densities of at least 750 g/l. In a preferred variant of the inventive composition having high bulk densities, the bulk density, however, is actually above 800 g/l, wherein bulk densities above 850 g/l can be particularly advantageous. The advantages of the soluble builder system are particularly important for these types of super compactates, as such compacted compositions set particular requirements with regard to the good dispersibility of the ingredients. In addition, the low-dose builder system, irrespective of the bulk density, leads to additional advantages by saving on packaging volume and reduces the chemicals introduced into the environment per wash cycle.

Any process known from the prior art is suitable for manufacturing such compositions.

The compositions are manufactured by blending together the different particulate components that comprise the ingredients of the detergents and/or cleaner, and which together form at least 60 wt. % of the total composition.

In this way the particulate components can be manufactured by spray drying, simple mixing or complex granulation processes, for example fluidized bed granulation. Preferably, at least one surfactant-containing component is manufactured by fluidized bed granulation.

In addition, it may be particularly preferred when aqueous preparations of the builders are sprayed together in a drier with other ingredients of detergents and/or cleaners, such that a granulation occurs at the same time as the drying. The dryer, into which the aqueous preparation is sprayed, can be any drying apparatus.

In a preferred process procedure, the drying is carried out as spray drying in a drying tower. For this, in the known method, the finely divided aqueous preparations encounter a dry gas flow. The applicant describes an embodiment of spray drying using superheated steam in a number of publications. The operating principle disclosed in those publications is also hereby expressly included in the subject of the disclosure of the present invention. Reference is made in particular to the following publications: DE-A-40 30 688 and the further developments according to DE-A-42 04 035; DE-A-42 04 090; DE-A-42 06 050; DE-A-42 06 521; DE-A-42 06 495; DE-A-42 08 773; DE-A-42 09 432 and DE-A-42 34 376.

In another preferred variant, especially when it is intended to prepare high bulk density compositions, the mixtures are subsequently subjected to a compaction step, wherein additional ingredients are blended with the compositions only after the compaction step.

In a preferred embodiment of the invention, the compaction of the ingredients takes place in a press agglomeration process. The press agglomeration process, to which the solid premix (dried detergent base) is subjected, can be carried out in various apparatuses. Different press agglomeration processes are differentiated according to the type of agglomerator used. The four most frequent and in the context of the present invention preferred press agglomeration processes are extrusion, roller press or roller compaction, punch press (pelletization) and tableting, so that in the context of the present invention, preferred press agglomeration operations are extrusion-, roller compaction-, pelletization- or tableting operations.

All of the cited processes have in common that the premix is densified under pressure and plasticized and the individual particles are pressed onto each other, and by reducing their porosity stick to each other. In all processes, (for tableting with limitations) the tooling can be heated to higher temperatures or cooled to remove the shear heating.

A binder can be used in all processes as a compaction auxiliary. In the interests of simplicity, the specification will hereinafter refer only to a binder or to the binder. However, it must be made clear at this juncture that, basically, several different binders and mixtures of various binders may also be used. A preferred embodiment of the invention is characterized by the use of a binder that is completely in the form of a melt at temperatures of at most 130° C., preferably at most 100° C. and more preferably up to 90° C. In other words, the binder will be selected according to the process and the process conditions or, alternatively, the process conditions and, in particular, the process temperature will have to be adapted to the binder if it is desired to use a particular binder.

The actual compacting process is preferably carried out at processing temperatures, which, at least in the compacting step, at least correspond to the temperature of the softening point if not to the temperature of the melting point of the binder. In one preferred embodiment of the invention, the process temperature is significantly above the melting point or above the temperature at which the binder is present as a melt. In a particularly preferred embodiment, however, the process temperature in the compacting step is no more than 20° C. above the melting temperature or the upper limit of the melting range of the binder. Although, technically, it is quite possible to set even higher temperatures, it has been found that a temperature difference of 20° C. in relation to the melting temperature or to the softening temperature of the binder is generally quite sufficient and even higher temperatures do not afford additional advantages. Accordingly it is particularly preferred, above all on energy grounds, to carry out the compacting step above, but as close as possible to, the melting point or rather to the upper temperature limit of the melting range of the binder. Controlling the temperature in this way has the further advantage that even heat-sensitive raw materials, for example peroxide bleaching agents, such as perborate and/or percarbonate, and also enzymes, can be increasingly processed without serious losses of active substance. The ability to exactly control the temperature of the binder, particularly in the crucial compacting step, i.e. between mixing/homogenizing of the premix and shaping, enables the process to be carried out very favorably in terms of energy consumption and with no damaging effects on the heat-sensitive constituents of the premix because the premix is only briefly exposed to the relatively high temperatures. In preferred press agglomeration processes, the working tools of the press agglomerator (the screw(s) of the extruder, the roller(s) of the roll compactor and the pressure roller(s) of the pellet press) are at a temperature of maximum 150° C., preferably of maximum 100° C. and, in a particularly preferred embodiment, maximum 75° C., the process temperature being 30° C. and, in a particularly preferred embodiment, maximum 20° C. above the melting temperature or rather the upper temperature limit of the melting range of the binder. The heat exposure time in the compression zone of the press agglomerator is preferably maximum 2 minutes and, more preferably, between 30 seconds and 1 minute.

Preferred binders that may be used either individually or in the form of mixtures with other binders are polyethylene glycols, 1,2-polypropylene glycols and modified polyethylene glycols and polypropylene glycols. The modified polyalkylene glycols include, in particular, the sulfates and/or the disulfates of polyethylene glycols or polypropylene glycols with a relative molecular weight between 600 and 12 000 and, more particularly, in the range from 1 000 to 4 000. A more detailed description of the modified polyalkylene glycol ethers can be found in the disclosure of the International patent application WO-A-93/02176. In the context of this invention, polyethylene glycols include polymers that have been produced, beside ethylene glycol, also C₃-C₅ glycols as well as glycerol and mixtures thereof as the starting molecules. In addition, they also include ethoxylated derivatives, such as trimethylol propane containing 5 to 30 EO. The preferably used polyethylene glycols can have a linear or branched structure, the linear polyethylene glycols being particularly preferred. Particularly preferred polyethylene glycols include those with relative molecular weights between 2 000 and 12 000, advantageously around 4 000. However, polyethylene glycols that are in the liquid state at room temperature/1 bar pressure may also be used as binders; these are principally polyethylene glycols with a relative molecular weight of 200, 400 and 600. However, these basically liquid polyethylene glycols should only be used in the form of a mixture with at least one other binder, this mixture again having to satisfy the requirements according to the invention, i.e. it must have a melting point or softening point of at least more than 45° C.

Other suitable binders are low molecular weight polyvinyl pyrrolidones and derivatives thereof with relative molecular weights of up to maximum 30 000. Relative molecular weight ranges between 3 000 to 30 000, for example around 10 000, are preferred. Polyvinyl pyrrolidones are preferably not used as the sole binder, but in combination with other binders, more particularly in combination with polyethylene glycols.

Other suitable binders are raw materials that have been shown to exhibit active detergent or cleaning characteristics, i.e. for example non-ionic surfactants with melting points of at least 45° C. or mixtures of non-ionic surfactants and other binders. Preferred non-ionic surfactants include alkoxylated fatty or oxo-alcohols, more particularly C₁₂-C₁₈ alcohols. In this connection, alkoxylation degrees, in particular degrees of ethoxylation, of on average 18 to 80 AO, in particular EO, per mol of alcohol and mixtures thereof have proved to be particularly advantageous. Above all, fatty alcohols containing on average 18 to 35 EO and, more particularly, an average of 20 to 25 EO show advantageous binder properties in the context of the present invention. Binder mixtures may optionally also comprise ethoxylated alcohols containing on average fewer EO units per mol of alcohol, for example tallow fatty alcohol containing 14 EO. However, these alcohols with a relatively low degree of ethoxylation are preferably used solely in admixture with alcohols having a higher degree of ethoxylation. The binders advantageously contain less than 50% by weight and, more particularly, less than 40% by weight of alcohols with a relatively low degree of ethoxylation, based on the total quantity of binder used. Above all, nonionic surfactants typically used in detergents or cleaners, such as C₁₂-C₁₈ alcohols containing on average 3 to 7 EO, which are basically liquid at room temperature, are preferably present in the binder mixtures in only such quantities that ensure less than 2% by weight of these non-ionic surfactants are available in the final product of the process. As described above, however, it is less preferred to incorporate room temperature-liquid, non-ionic surfactants in the binder mixtures. In a particularly advantageous embodiment, these types of non-ionic surfactants do not form part of the binder mixture because not only do they reduce the softening point of the mixture, they can also contribute towards tackiness of the end product and moreover, because of their tendency to gel on contact with water, often fail to adequately satisfy the requirement that the binder/partition in the end product should dissolve quickly. Similarly, the binder mixture preferably does not comprise the anionic surfactants or their precursors, namely the anionic surfactant acids, typically encountered in detergents or cleaners. Other non-ionic surfactants suitable as binders are the fatty acid methyl ester ethoxylates with no tendency to gel, in particular those containing on average 10 to 25 EO (for a more detailed description of this group of substances, see below). Particularly preferred representatives of this group of substances are methyl esters based predominantly on C₁₆-C₁₈ a fatty acids, for example hydrogenated beef tallow methyl ester containing on average 12 EO or 20 EO. In a preferred embodiment of the invention, a mixture containing C₁₂-C₁₈ fatty alcohol based on coco or tallow with on average 20 EO and polyethylene glycol with a relative molecular weight of 400 to 4 000 is employed as the suitable binder. In a further preferred embodiment of the invention, a mixture comprising predominantly C₁₆-C₁₈ fatty acid based methyl esters with on average 10 to 25 EO, in particular hydrogenated beef tallow methyl ester with on average 12 EO or 20 EO, and a C₁₂-C₁₈ fatty alcohol based on coco or tallow with on average 20 EO and/or polyethylene glycol with a relative molecular weight of 400 to 4 000 is used as the binder.

Binders based either solely on polyethylene glycols with a relative molecular weight of around 4 000 or on a mixture of C₁₂-C₁₈ fatty alcohol based on coco or tallow with on average 20 EO and one of the above-described fatty acid methyl ester ethoxylates or on a mixture of C₁₂-C₁₈ fatty alcohol based on coco or tallow with on average 20 EO, one of the above-described fatty acid methyl ester ethoxylates and a polyethylene glycol, more particularly with a relative molecular weight of around 4 000, have proved to be particularly advantageous embodiments of the invention.

Besides the substances mentioned here, other suitable substances may be present in the binder in small quantities.

Immediately after leaving the production unit, the compacted material is preferably at temperatures of not more than 90° C., temperatures of 35 to 85° C. being particularly preferred. It has been found that exit temperatures, principally in the extrusion process, of 40 to 80° C., for example up to 70° C., are particularly advantageous.

In a preferred embodiment of the invention, the process according to the invention is carried out by extrusion as described, for example in European patent EP-B 0 486 592 or International patent applications WO 93/02176 and WO 94/09111 or WO 98/12299. In this extrusion process, a solid premix is extruded under pressure to form a strand that after emerging from the extrusion die is cut into pellets of predetermined size by means of a cutting unit. The solid, homogeneous premix comprises a plasticizer and/or lubricant that cause(s) the premix to plastically soften under the applied pressure or under the input of specific energy and become extrudable. Preferred plasticizers and/or lubricants are surfactants and/or polymers.

Particulars of the actual extrusion process can be found in the above-cited patents and patent applications to which reference is hereby expressly made. In a preferred embodiment of the invention, the premix is fed, preferably continuously, to a planetary roll extruder or to a twin-screw extruder with co-rotating or counter-rotating screws, whose barrel and extrusion/granulation head can be heated to the predetermined extrusion temperature. Under the shear effect of the extruder screws, the premix is compacted under pressure, preferably at least 25 bar, or with extremely high throughputs, even lower, depending on the equipment used, then compressed, plasticized, extruded in the form of fine strands through the multiple-bore die plate in the extruder head and, finally, reduced in size by means of a rotating cutting blade, preferably into substantially spherical or cylindrical pellets. The bore diameter of the multiple-bore die plate and the length to which the strands are cut are adapted to the selected pellet size. In this embodiment, pellets are produced in a substantially uniformly predetermined particle size, the absolute particle sizes being adaptable to the particular application envisaged. In general, particle diameters of up to a maximum of 0.8 cm are preferred. Important embodiments provide for the production of uniform pellets in the millimeter range, for example in the range from 0.5 to 5 mm and more particularly in the range from about 0.8 to 3 mm. In one important embodiment, the length-to-diameter ratio of the primary pellets is in the range from about 1: I to about 3:1. It is further preferred that the still plastic primary pellets be subjected to another shaping process step in which the edges present on the crude extrudate are rounded off such that, ultimately, spherical or substantially spherical extrudate pellets can be obtained. If desired, small quantities of drying powder, for example zeolite powder, such as zeolite NaA powder, can be used in this step. This shaping step may be carried out in commercially available spheronizing machines. It is important in this regard to ensure that only small quantities of fines are formed in this stage. According to the present invention, drying, which is described as a preferred embodiment in the prior art documents cited above, may be carried out in a subsequent step but is not absolutely essential. It may even be preferred not to carry out drying after the compacting step.

Alternatively, extrusion/compression steps may also be carried out in low-pressure extruders, in a Kahl press (manufacturer: Amandus Kahl) or in a so-called Bextruder (manufacturer: Bepex).

In a particularly preferred embodiment of the invention, the temperature prevailing in the transition section of the screw, the pre-distributor and the die plate is controlled in such a way that the melting temperature of the binder or rather the upper limit of the melting range of the binder is at least reached and preferably exceeded. The temperature exposure time in the compression zone of the extruder is preferably less than 2 minutes and, more particularly, between 30 seconds and 1 minute.

In a further preferred embodiment of the present invention, the process according to the invention is carried out by roll compaction. In this variant, the premix is introduced between two rollers, either smooth or provided with depressions of defined shape, and rolled under pressure between the two rollers to form a sheet-like compactate. The rollers exert a high linear pressure on the compound and may be additionally heated or cooled as required. Where smooth rollers are used, smooth un-textured compactate sheets are obtained. By contrast, where textured rollers are used, correspondingly textured compactates can be produced, in which for example certain shapes can be imposed in advance on the subsequent detergent particles. The sheet-like compactate is then broken up into smaller pieces by a chopping and size-reducing process and can thus be processed to pellets, which can be further refined and, more particularly, converted into a substantially spherical shape by further surface treatment processes known per se.

In roll compaction too, the temperature of the press tooling, i.e. the rollers, is preferably maximum 150° C., more preferably maximum 100° C. and most preferably maximum 75° C. Particularly preferred production processes based on roll compaction are carried out at temperatures of 10° C. and, in particular, at most 5° C. above the melting temperature of the binder or the upper temperature limit of the melting range of the binder. The temperature exposure time in the compression zone of the rollers, either smooth or provided with depressions of defined shape, is preferably at most 2 minutes and, more particularly, between 30 seconds and 1 minute.

In a further preferred embodiment of the present invention, the process according to the invention is carried out by pelleting. In this process, the premix is applied to a perforated surface and is plasticized and forced through the perforations by a pressure roller. In conventional pellet presses, the premix is compacted under pressure, plasticized, forced through a perforated surface in the form of fine strands by means of a rotating roller and, finally, is size-reduced to pellets by a cutting unit. The pressure roller and the perforated die may assume many different designs. For example, flat perforated plates are used, as are concave or convex ring dies, through which the material is pressed by one or more pressure rollers. In perforated-plate presses, the pressure rollers may also be conical in shape. In ring die presses, the dies and pressure rollers may co-rotate or counter-rotate. Equipment suitable for carrying out the process according to the invention is described, for example, in the German Offenlegungsschrift DE 38 16 842. The ring die press disclosed in this document consists of a rotating ring die permeated by pressure bores and at least one pressure roller operatively connected to the inner surface thereof, which presses the material delivered to the die space through the pressure bores into a discharge unit. The ring die and pressure roller are designed to be driven in the same direction thereby reducing the applied shear and hence reducing the increase in temperature of the premix. However, the pelleting process may of course also be carried out with heatable or coolable rollers to enable the premix to be adjusted to a required temperature.

In roll compaction too, the temperature of the press tooling, i.e. the press cylinders or rollers, is preferably maximum 150° C., more preferably maximum 100° C. and most preferably maximum 75° C. Particularly preferred production processes based on roll compaction are carried out at temperatures of 10° C. and, in particular, at most 5° C. above the melting temperature of the binder or the upper temperature limit of the melting range of the binder.

Another press agglomeration process that may be used in accordance with the invention is tableting. Shaped bodies of detergents or cleaners are produced by this process. Accordingly, in another preferred embodiment of the invention, the detergents or cleaners are present in the form of molded bodies, preferably tablets which may consist of a single phase or of several, more particularly two or three, different phases.

In order to facilitate the disintegration of the highly compacted molded bodies, disintegration aids, so-called tablet disintegrators, may be incorporated in them to shorten their disintegration times. According to Römpp (9th Edition, Vol. 6, page 4440) and Voigt “Lehrbuch der pharmazeutischen Technologie” (6th Edition, 1987, pages 182-184), tablet disintegrators or disintegration accelerators are auxiliaries, which promote the rapid disintegration of tablets in water or gastric juices and the release of the pharmaceuticals in an absorbable form.

These substances, which are also known as “disintegrators” by virtue of their effect, increase in volume on contact with water such that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

In a preferred variant, the detergent and cleaner molded bodies comprise 0.5 to 10 wt. %, advantageously 3 to 7 wt. % and in particular 4 to 6 wt. % of one or a plurality of disintegration aids, each based on the weight of the molded body.

In the context of the present invention, preferred disintegrators that are used are based on cellulose, and therefore the preferred detergent and cleaner molded objects comprise such a cellulose-based disintegrator in amounts of 0.5 to 10% by weight, preferably 3 to 7% by weight and especially 4 to 6% by weight. Pure cellulose has the formal empirical composition (C₆H₁₀O₅)ₙ and, formally, is a β-1,4-polyacetal of cellobiose that, in turn, is made up of two molecules of glucose. In this context, suitable celluloses consist of ca. 500 to 5000 glucose units and consequently have average molecular weights of 50 000 to 500 000. In the context of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxyl groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and amino celluloses. The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. A particularly preferred cellulose-based disintegrator is pure cellulose, free from cellulose derivatives.

The cellulose, used as the disintegration aid, is advantageously not added in the form of fine particles, but rather conveyed in a coarser form prior to addition to the premix that will be compressed, for example granulated or compacted. Detergent and cleaner tablets that comprise granular or optionally co-granulated disintegrators are described in German patent applications DE 197 09 991 and DE 197 10 254 and in International patent application WO 98/40463. Further particulars of the production of granulated, compacted or co-granulated cellulose disintegrators can also be found in these patent applications. The particle sizes of such disintegrators are mostly above 200 μm, advantageously with 90 wt. % between 300 and 1600 μm and particularly with at least 90 wt. % between 400 and 1200 μm. In the context of the present invention, the abovementioned coarser disintegration aids, also described in greater detail in the cited publications, are preferred disintegration aids and are commercially available for example, from the Rettenmaier Company under the trade name Arbocel® TF-30-HG.

Microcrystalline cellulose can be used as a further cellulose-based disintegrator, or an ingredient of this component. This microcrystalline cellulose is obtained by the partial hydrolysis of cellulose under conditions, which only attack and fully dissolve the amorphous regions (ca. 30% of the total cellulosic mass) of the cellulose, leaving the crystalline regions (ca. 70%) intact. Subsequent disaggregation of the microfine cellulose, obtained by hydrolysis, yields microcrystalline celluloses with primary particle sizes of ca. 5 μm and for example, compactable granules with an average particle size of 200 μm.

In the context of the present invention, preferred detergent and cleaner tablets additionally comprise a disintegration aid, advantageously a disintegration aid based on cellulose, preferably in granular, cogranulated or compacted form, in quantities of 0.5 to 10 wt. %, preferably 3 to 7 wt. % and particularly 4 to 6 wt. %, each based on the weight of the tablet.

The molded bodies according to the invention are manufactured first of all by dry-mixing the constituents, some or all of which may have been pre-granulated, and subsequently shaping the dry mixture, in particular by compression to tablets, in which context it is possible to have recourse to conventional processes. To produce the molded bodies according to the invention, the premix is compacted in a so-called die between two punches to form a solid compactate. This operation, which is referred to below for short as tableting, is divided into four sections: metering, compaction (elastic deformation), plastic deformation, and ejection.

First, the premix is introduced into the die, the fill level and thus the weight and form of the resulting tablet being determined by the position of the lower punch and by the shape of the compression tool. Even in the case of high tablet throughputs, constant metering is preferably achieved by volumetric metering of the premix. In the subsequent course of tableting, the upper punch contacts the premix and is lowered further in the direction of the lower punch. In the course of this compaction, the particles of the premix are pressed closer to one another, with a continual reduction in the void volume within the filling between the punches. When the upper punch reaches a certain position (and thus when a certain pressure is acting on the premix), plastic deformation begins, in which the particles coalesce and the tablet is formed. Depending on the physical properties of the premix, a portion of the premix particles is also crushed and at even higher pressures, there is sintering of the premix. With an increasing compression rate, i.e., high throughputs, the phase of elastic deformation becomes shorter and shorter, with the result that the tablets formed may have more or less large voids. In the final step of tableting, the finished tablet is ejected from the die by the lower punch and conveyed away by means of downstream transport means. At this point in time, it is only the weight of the tablet which has been ultimately defined, since the compactates may still change their form and size as a result of physical processes (elastic relaxation, crystallographic effects, cooling, etc).

Tableting takes place in customary commercial tableting presses, which may in principle be equipped with single or double punches. In the latter case, pressure is built up not only using the upper punch; the lower punch as well moves toward the upper punch during the compression operation, while the upper punch presses downward. For small production volumes it is preferred to use eccentric tableting presses, in which the punch or punches is or are attached to an eccentric disk, which in turn is mounted on an axle having a defined speed of rotation. The movement of these compression punches is comparable with the way in which a conventional four-stroke engine works. Compression can take place with one upper and one lower punch, or else a plurality of punches may be attached to one eccentric disk, the number of die bores being increased correspondingly. The throughputs of eccentric presses vary, depending on model, from several hundred up to a maximum of 3 000 tablets per hour.

For greater throughputs, rotary tableting presses are chosen, in which a relatively large number of dies is arranged in a circle on a so-called die table. Depending on the model, the number of dies varies between 6 and 55, larger dies also being commercially available. Each die on the die table is allocated an upper punch and a lower punch, it being again possible for the compressive pressure to be actively built up by the upper punch or lower punch only, or else by both punches. The die table and the punches move around a common, vertical axis, and during rotation the punches, by means of rail-like cam tracks, are brought into the positions for filling, compaction, plastic deformation, and ejection. At those sites where considerable raising or lowering of the punches is necessary (filling, compaction, ejection), these cam tracks are assisted by additional low-pressure sections, low-tension rails, and discharge tracks. The die is filled by way of a rigid supply means, known as the filling shoe, which is connected to a stock vessel for the premix. The compressive pressure on the premix can be adjusted individually for upper punch and lower punch by way of the compression paths, the build up of pressure taking place by the rolling movement of the punch shaft heads past displaceable pressure rolls. In order to increase the throughput, rotary presses may also be provided with two filling shoes, in which case only one half-circle need be traveled to produce one tablet. For the production of two-layer and multilayer tablets, a plurality of filling shoes is arranged in series, and the gently pressed first layer is not ejected before further filling. By means of an appropriate process regime it is also possible in this way to produce laminated tablets and inlay tablets having a construction like that of an onion skin, where in the case of the inlay tablets the top face of the core or of the core layers is not covered and therefore remains visible. Rotary tableting presses can also be equipped with single or multiple tools, such that, for example, an outer circle with 50 bores and an inner circle with 35 bores can be used simultaneously for compression. The throughputs of modern rotary tableting presses reach more than a million tablets per hour.

In the context of the present invention, suitable tableting machines are obtainable, for example, from the following companies: Apparatebau Holzwarth GbR, Asperg, Wilhelm Fette GmbH, Schwarzenbek, Hofer GmbH, Weil, KILIAN, Cologne, KOMAGE, Kell am See, KORSCH Pressen GmbH, Berlin, Mapag Maschinenbau AG, Berne (CH) and Courtoy NV, Halle (BE/LU). Aparticularly suitable apparatus is, for example, the hydraulic double-pressure press HPF 630 from LAEIS, D.

The tablets can be made in predefined shapes and predefined sizes. Suitable shapes are virtually any easy-to-handle shapes, for example slabs, bars, cubes, squares and corresponding shapes with flat sides and, in particular, cylindrical forms of circular or oval cross-section. This last embodiment encompasses shapes from tablets to compact cylinders with a height-to-diameter ratio of more than 1.

The portioned pressings may be formed as separate individual elements that correspond to a predetermined dose of the detergent. However, it is also possible to form pressings which combine several such units in a single pressing, smaller portioned units being easy to break off in particular through the provision of predetermined weak spots. For the use of laundry detergents in machines of the standard European type with horizontally arranged mechanics, it can be of advantage to produce the portioned pressings as cylindrical or square tablets, preferably with a diameter-to-height ratio of about 0.5:2 to 2:0.5. Commercially available hydraulic presses, eccentric presses and rotary presses are particularly suitable for the production of pressings such as these.

The three-dimensional form of another embodiment of the tablets is adapted in its dimensions to the dispensing compartment of commercially available domestic washing machines, such that the tablets can be introduced directly, i.e. without a dosing aid, into the dispensing compartment where they dissolve during the dispensing step. However, it is of course readily possible, and preferred in accordance with the present invention, to use the detergent tablets in conjunction with a dosing aid.

Another preferred tablet that can be produced has a plate-like or slab-like structure with alternately thick long segments and thin short segments, such that individual segments can be broken off from this “bar” at the predetermined weak spots, which the short thin segments represent, and introduced into the machine. This “bar” principle can also be embodied in other geometric forms, for example vertical triangles that are only joined to one another at one of their longitudinal sides.

In another possibility, however, the various components are not compressed to form a uniform tablet; instead the tablets obtained comprise a plurality of layers, i.e. at least two layers. These various layers may have different rates of dissolution. This can provide the tablets with favorable performance properties. If, for example, the tablets contain components which adversely affect one another, one component may be integrated in the more quickly dissolving layer while the other component may be incorporated in a more slowly dissolving layer such that the first component can already have reacted away by the time the second component dissolves. Detergent or cleaning agent tablets are also preferred, in which at least two phases comprise the same active ingredient in different amounts. The term “different amounts” in this connection does not refer to the absolute quantity of the ingredient in the phase, but rather to the relative amount based on the phase weight, thus illustrates a weight percent indication, based on the individual phases. In the context of the present invention, it can be particularly preferred if the silicon compounds according to the invention, and preferably also the total perfume mixture, are present in other phases of the tablet than those in which the bleaching agent is comprised. Likewise, it is preferred if alkalinity sources, such as alkali metal hydroxides, alkali metal carbonates, alkali metal hydrogen carbonates, alkali metal sesquicarbonates, alkali silicates, alkali metasilicates and mixtures thereof, at least to the greatest extent, preferably however entirely, are present in other phases of the tablet than the silicone compounds according to the invention or particularly preferably the totality of the perfume mixture. The various layers of the tablets can be arranged in the form of a stack, in which case the inner layer(s) dissolve at the edges of the tablet before the outer layers have completely dissolved. Alternatively, however, the inner layer(s) may also be completely surrounded by the layers lying further to the outside, which prevents constituents of the inner layer(s) from dissolving prematurely.

In a further preferred embodiment of the invention, a tablet consists of at least three layers, i.e. two outer layers and at least one inner layer, a peroxy bleaching agent being present in at least one of the inner layers, whereas, in the case of the stack-like tablet, the two cover layers and, in the case of the envelope-like tablet, the outermost layers are free from peroxy bleaching agent. It is also possible to spatially separate peroxy bleaching agent and optionally present bleach activators and/or enzymes from one another in one and the same tablet. Multilayer tablets such as these have the advantage that they can be used not only via a dispensing compartment or via a dosing unit which is added to the wash liquor, instead it is also possible in cases such as these to introduce the tablet into the machine in direct contact with the fabrics without any danger of spotting by bleaching agent or the like.

Similar effects can also be obtained by coating individual constituents of the detergent and cleaning composition to be compressed or the tablet as a whole. To this end, the tablets to be coated may be sprayed, for example, with aqueous solutions or emulsions or a coating may be obtained by the process known as melt coating.

After pressing, the detergent and cleaning tablets have a high stability. The fracture resistance of cylindrical tablets can be determined from the diametral fracture stress. This in turn can be determined in accordance with the following equation:

$$σ = \frac{2 P}{π Dt}$$

where σ represents the diametral fracture stress (DFS) in Pa, P is the force in N which leads to the pressure applied to the tablet that results in fracture thereof, D is the diameter of the tablet in meters and t is its height.

In a preferred embodiment, the cosmetic compositions according to the invention are aqueous preparations that comprise surfactants and are particularly suitable for treating keratinic fibers, particularly human hair, or for treating skin.

The hair treatment preparations mentioned are in particular preparations for treating human head hair. The most common preparations in this category may be divided into hair shampoos, hair care preparations, hair setting preparations and hair shaping preparations and also hair colorants and hair removers. Preferred preparations according to the invention containing surface-active ingredients are in particular hair care and washing preparations. A hair washing preparation or shampoo consists of 10 to 20 and, in some cases, as many as 30 ingredients. These aqueous preparations are generally in liquid or paste-like form.

Fatty alcohol polyglycol ether sulfates (ether sulfates, alkyl ether sulfates), partly in combination with other, generally anionic surfactants, are mainly used for the most important group of ingredients, the surface-active ingredients or “washing-active” constituents. Besides good cleaning performance and insensitivity to water hardness, shampoo surfactants should possess compatibility with skin and mucous membranes. Ready biodegradability is a legal requirement. Besides the alkyl ether sulfates, preferred preparations also contain other surfactants, such as alkyl sulfates, alkyl ether carboxylates, preferably with degree of ethoxylation of 4 to 10, and surface-active protein/fatty acid condensates. Protein/abietic acid condensate is to be particularly mentioned in this regard. Sulfosuccinic acid esters, amidopropyl betaines, amphoacetates and amphodiacetates and also alkyl polyglycosides are other preferred surfactants for hair shampoos. Another, very diverse group of ingredients are the auxiliaries. For example, large additions of non-ionic surfactants, such as ethoxylated sorbitan esters or protein hydrolyzates, improve compatibility or have a germ-reducing effect, for example in baby shampoos; natural oils or synthetic fatty acid esters, for example, act as refatting agents for preventing excessive degreasing in the washing of hair; glycerol, sorbitol, propylene glycol (see propanediols), polyethylene glycols and other polyols act as moisturizers. Cationic surfactants, such as quaternary ammonium compounds for example, may be added to the shampoos to improve wet combability and reduce electrostatic charging of the hair after drying. Dyes and pearlizing pigments are added to obtain a colored, sparkling appearance. Thickeners belonging to various classes of compounds may be used to adjust the required viscosity; pH stability is achieved by buffers, for example based on citrate, lactate or phosphate. Preservatives, such as 4-hydroxybenzoic acid ester for example, are added to guarantee stability and storability; ingredients sensitive to oxidation can be protected by addition of antioxidants, such as ascorbic acid, butyl methoxyphenol or tocopherol.

A third group of ingredients is formed by special active principles for special shampoos, for example oils, herb extracts, proteins, vitamins and lecithins in shampoos for greasy hair, for particularly dry hair, for stressed or damaged hair. Active principles in anti-dandruff shampoos mostly have a broad growth-inhibiting effect against fungi and bacteria. The fungistatic properties in particular, for example of pyrithione salts, were shown to be responsible for a good anti-dandruff effect. The shampoos contain perfume oils for a pleasant perfume note. The shampoos may exclusively contain the silicon compounds according to the invention although, it is likewise preferred if they comprise not only these but also other fragrances. Any of the usual fragrances allowed in shampoos may be used.

The object of hair care preparations is to keep freshly regrown hair in its natural state for as long as possible and to restore it in the event of damage. Features which characterize this natural state are a silky luster, low porosity, bouncy and soft body and a pleasantly soft feel. An important requirement in this regard is a clean, dandruff-free and not too greasy scalp. Hair care preparations today include a number of different products of which the most important representatives are pretreatments, hair lotions, styling aids, rinses and conditioners and of which the composition, as with shampoos, is roughly divided into basic ingredients, auxiliaries and special active principles.

Basic ingredients include fatty alcohols, inter alla cetyl alcohol (1-hexadecanol) and stearyl alcohol (1-octadecanol), waxes such as beeswax, wool wax (lanolin), spermaceti and synthetic waxes, paraffins, Vaseline, paraffin oil and as solvents, inter alia ethanol, 2-propanol and water. Auxiliaries are emulsifiers, thickeners, preservatives, antioxidants, dyes and perfume oils. Today, the most important group of special active principles in hair care preparations are the quaternary ammonium compounds. These are divided into monomeric quaternary ammonium compounds (for example alkyl trimethylammonium halide with inter alia the lauryl, cetyl or stearyl group as the alkyl group) and polymeric quaternary ammonium compounds [for example quaternary cellulose ether derivatives or poly(N,N-dimethyl-3,4-methylenepyrrolidinium chloride)]. Their effect in hair care preparations is based on the fact that the positive charge of the nitrogen atoms of this compound can be added onto the negative charges of the hair keratin, through its higher cysteic acid content, damaged hair contains more negatively charged acid groups and, accordingly, can take up more quaternary ammonium compounds. These quaternary ammonium compounds—also known as “cationic hair care agents” because of their cationic character—have a smoothing effect on the hair, improve combability, reduce electrostatic charging and improve feel and luster. The polymeric quaternary ammonium compounds adhere to the hair so well that their effect is still in evidence after several washes. Organic acids, such as citric acid, tartaric acid or lactic acid, are often used to establish an acidic medium. The water-soluble protein hydrolyzates are readily absorbed onto the hair keratin by virtue of their close chemical relationship. The largest group of special active principles in hair care preparations consists of various plant extracts and vegetable oils of which most have been in use for some time without their effectiveness having been attributed scientifically satisfactorily in every case to their particular effect. Similarly, the effectiveness of vitamins used in hair care preparations has only been established in individual cases. To avoid overrapid refatting, some hair lotions comprise substances, such as certain tar ingredients, cysteic acid derivatives or glycyrrhizin; the intended reduction of sebaceous gland production has also not been clearly established. By contrast, the effectiveness of anti-dandruff agents has been satisfactorily demonstrated. Accordingly, they are used in corresponding hair lotions and other hair care preparations.

The aqueous preparations for treating skin are, in particular, skin care preparations for human skin. Skin care begins with cleansing for which soaps are primarily used. Here, soaps are diferentiated into solid soaps, usually bar soaps, and liquid soaps. In a preferred embodiment, therefore, the cosmetic preparations are present in the form of shaped bodies, which contain surface-active ingredients. In a preferred embodiment, the most important ingredients of such shaped bodies are the alkali metal salts of the fatty acids of natural oils and fats, preferably with chains of 12 to 18 carbon atoms. Since lauric acid soaps foam particularly well, coconut oil and palm kernel oil soaps rich in lauric acid are preferred raw materials for the production of toilet soaps. The sodium salts of the fatty acid mixtures are solid and their potassium salts soft and paste-like. For saponification, the dilute sodium or potassium hydroxide solution is added to the fatty raw materials in a stoichiometric ratio such that a hydroxide excess of max. 0.05% is present in the final soap. In many cases, soaps today are no longer produced directly from the fats, but instead from the fatty acids obtained by lipolysis. Typical soap additives are fatty acids, fatty alcohols, lanolin, lecithin, vegetal oils, partial glycerides and other fat-like substances for refatting the cleansed skin, antioxidants such as ascorbyl palmitate or tocopherol for preventing autoxidation of the soap (rancidity), complexing agents, such as nitrilotriacetate, for binding traces of heavy metals which could catalyze autoxidative deterioration, perfume oils for obtaining the required fragrance notes, dyes for coloring the bar soaps and optionally special additives.

The most important types of toilet soaps are:
toilet soaps containing 20-50% coconut oil in the fatty component, up to 5% refatting agents and 0.5-2% perfume oil—they form the largest share of toilet soaps;
luxury soaps containing up to 5% perfume oils, in some cases particularly expensive perfume oils;
deodorant soaps with additions of deodorizing agents such as, for example, 3,4,4′-trichlorocarbanilide (Triclocarban);
cream soaps with particularly high percentages of refatting and skin-creaming substances;
baby soaps with good refatting and additional skin care ingredients such as, for example, camomile extracts, at best very weakly perfumed;
skin protecting soaps with high percentages of refatting substances and other skin care and protecting additives, for example proteins;
transparent soaps with additions of glycerine, sugars and the like which prevent the fatty acid salts from crystallizing in the solidified soap melt and are thus responsible for a transparent appearance;
floating soaps with a density of <1 produced by the controlled incorporation of air bubbles during the production process.

Soaps can also be provided with abrasive additives for cleaning particularly soiled hands. Where soap is used for washing, a pH of 8 to 10 is automatically established in the wash liquor. This alkalinity neutralizes the natural acidic jacket of the skin (pH 5-6). Although this is reformed relatively quickly in the case of normal skin, irritation can occur in the case of sensitive or predamaged skin. Another disadvantage of soaps is the formation of insoluble lime soaps in hard water. These disadvantages do not arise with syndet soaps. They are based on synthetic anionic surfactants, which may be processed with builders, refatting agents and other additives to form soap-like bars. Their pH can be varied within wide limits and is generally adjusted to a neutral pH of 7 or adapted to the acid jacket of the skin—to a pH of 5.5. They have excellent cleaning performance, foam in any water hardness and even in sea water. On account of their intensive cleaning and degreasing effect, the content of refatting additives has to be far higher than in normal soaps. The disadvantage of syndet soaps is their relatively high price.

Liquid soaps are based both on potassium salts of natural fatty acids and on synthetic anionic surfactants. They contain fewer washing-active substances in aqueous solution than the solid soaps and have the usual additives, optionally with viscosity-regulating constituents and pearlizing additives. On account of their convenient and hygienic application from dispensers, they are mainly used in public toilets and the like. Wash lotions for particularly sensitive skin are based on mild-acting synthetic surfactants with additions of skin care substances and are adjusted to a neutral or mildly acidic pH (5.5).

There are a number of other preparations for mainly facial cleansing, including face lotions, cleansing lotions, milks, creams, pastes; face packs are used partly for cleaning, but mainly for invigorating and caring for facial skin. Face lotions are mostly aqueous alcohol solutions with low surfactant contents and other skin care agents. Cleansing lotions, milks, creams and pastes are mostly based on o/w emulsions with relatively small contents of fatty components and cleansing and skin-care additives. So-called scruffing and peeling preparations contain mildly keratolytic substances for removing the uppermost, dead horny layers of skin, in some cases with additions of abrasive powders. The almond paste long used as a mild skin cleanser is still often a constituent of such preparations. In addition, preparations for cleaning dirty skin contain antibacterial and anti-inflammatory substances because the accumulations of tallow in comedos (blackheads) form nutrient media for bacterial infections and tend towards inflammation. The broad range of various skin cleansing products available varies in composition and content of diverse active substances according to the various skin types and to special treatment goals.

The bath additives available for cleansing the skin in bathtubs or shower cubicles are widely used. Bath salts and bath tablets are intended to soften, color and perfume the bath water and generally contain no washing-active substances. By softening the bathwater, they enhance the cleansing power of soaps, but are primarily intended to have an invigorating effect and to add to the pleasure of bathing. Foam baths are more important. Where they have a relatively high content of refatting agents and skin care additives, they are also known as cream baths.

Shower baths together with foam baths have been successful on the market since about 1970 and, since 1986, have outstripped the latter in terms of production volume. They are similar in composition to liquid hair shampoos, but instead of hair care additives, contain special skin care additives. Combined preparations suitable for the skin and hair have also recently appeared on the market.

The care of the skin after cleansing has two key objectives: on the one hand, it is intended to return to the skin the ingredients removed uncontrollably during washing, such as horny cells, sebum lipids, acid formers and water, and to re-establish the natural equilibrium state, on the other hand it is intended to counteract above all the natural ageing process of the skin and the possible damage attributable to weather and environmental influences. Skin care and skin protection preparations are available in large numbers and in many forms. The most important are skin creams, lotions, oils and gels. Creams and lotions are based on o/w (oil-in-water) emulsions or w/o (water-in-oil) emulsions. The main constituents of the oil or fatty or lipid phase are fatty alcohols, fatty acids, fatty acid esters, waxes, Vaseline, paraffins and other fatty and oil components of mainly natural origin. Besides water, the aqueous phase mainly contains moisture regulating and moisture-sustaining substances as key skin care ingredients and also consistency or viscosity-regulating additives. Other additives, such as preservatives, antioxidants, complexing agents, perfume oils, colorants and special active principles, are incorporated in one of the two above-mentioned phases depending on their solubility and their stability properties. The choice of the emulsifier system is crucial to the type of emulsion and its properties. The emulsifier system may be selected on the HLB principle.

Creams may be divided into “day creams” and “night creams” according to their range of application. Day creams are mostly built up as o/w emulsions and are quickly absorbed by the skin without leaving any greasiness behind. Because of this, they are also sometimes referred to as dry creams, matt creams or vanishing creams Night creams are mostly w/o emulsions, are absorbed relatively slowly by the skin and often contain special active principles that are supposed to regenerate the skin during sleep. Some of these preparations are also known as “nourishing creams” although “nourishing” of the cell metabolism in the skin can only take place via the circulation; accordingly, the name “nourishing cream” is disputed. So-called cold creams are mixed o/w and w/o emulsions, the oil phase quantitatively predominating. With traditional cold creams, the unstably emulsified water was released during application and, by evaporating, produced a cooling effect that gave this preparation its name.

The many special ingredients used in skin care preparations and the effects attributed to them cannot be discussed in detail here. They include milk protein products, egg yolk, lecithins, lipoids, phosphatides, cereal germ oils, vitamins, especially vitamin F and biotin formerly known as skin vitamin (vitamin H), and hormone-free placenta extracts. Hormones sometimes previously used are no longer used because they are classified as medicinal active principles and cannot be used in cosmetic preparations.

Skin oils are one of the oldest forms of skin care products and are still used today. They are based on non-drying vegetable oils, such as almond oil or olive oil with additions of natural vitamin oils, such as wheat germ oil or avocado oil, and oily plant extracts from, for example, St. John's wort, camomile and the like. The addition of antioxidants against rancidity is essential; desired fragrance notes are obtained by addition of perfume or essential oils; an addition of paraffin oil or liquid fatty acid esters optimizes the performance properties.

Skin gels are semi-solid, transparent products, which are stabilized by corresponding gel formers. They are divided into oleogels (water-free), hydrogels (oil-free) and oil/water gels. The type selected will depend on the desired application. The oil/water gels contain high emulsifier contents and have certain advantages over emulsions both from the aesthetic perspective and from the application perspective.

Footbaths are intended to have a cleansing, refreshing, circulation promoting, invigorating and deodorizing effect and a softening effect on hard skin. Footbath additives are available as bath salts and foam baths. They consist, for example, of basic mixtures of sodium carbonate, sodium hydrogen carbonate and sodium perborate or sodium hexametaphosphate (see. condensed phosphates), sodium sulfate, sodium perborate and 1% sodium lauryl sulfate as the foam component with antihydrotic, deodorizing, optionally bactericidal and/or fungicidal additives and also dyes and perfumes. Foot powders, which are applied after washing of the feet and/or are scattered into stockings and shoes, are intended to have a skin-smoothing, cooling, moisture-absorbing, perspiration-inhibiting, antiseptic and deodorizing effect and a softening effect on hard skin. They generally consist of up to 85% talcum (see talcum) with additions of silica powder, aluminium hydroxychloride, salicylic acid and optionally bactericides, fungicides, deodorants and perfumes. Foot creams or foot balsams are used for skin care and for massaging foot and lower leg muscles. Foot creams are generally o/w emulsions of, for example, 30% isopropyl myristate, 10% polysorbate, 4.2% aluminium metahydroxide and 55.8% water as the basic formulation; foot balsams are mostly anhydrous and contain, for example, 85% Vaseline, 5% paraffin, 3% lanolin, 3% methyl salicylate, 2% camphor, 1% menthol and 1% eucalyptus oil. Hard skin removers such as, for example, “rubbing creams” are rubbed into the skin until the horny layer is removed in the form of crumbs. A basic formulation consists of 25% paraffin, 2% stearic acid, 2% beeswax, 2% spermaceti, 2% glycerol monostearate, 0.5% 2,2′,2″-nitrilotriethanol, 1% perfume oil, 0.2% 4-hydroxybenzoic acid and 65.3% water. Nail groove tinctures are used to soften horny skin in the nail grooves and to keep the edges of ingrowing nails soft, mainly on the big toes. A basic formulation consists of 10% 2,2′,2″-nitrilotriethanol, 15% urea, 0.5% fatty alcohol polyglycol ether and 74.5% water.

Other preferred cosmetic preparations according to the invention are preparations for influencing body odor, more especially deodorants. Deodorants are intended to mask, remove or destroy odors. Unpleasant body odors are formed by the bacterial decomposition of perspiration, particularly in the damp underarm region where microorganisms find good living conditions. Accordingly, the most important ingredients of deodorants are germ-inhibiting substances. Particularly preferred germ inhibitors are those which possess wide selective activity against the bacteria responsible for body odor. However, preferred active principles merely have a bacteriostatic effect and do not kill off the entire bacterial flora. Germ inhibitors are generally any suitable preservatives that act specifically against gram-positive bacteria. Examples include lrgasan DP 300 (Triclosan, 2,4,4′-trichloro-2′-hydroxydiphenyl ether), chlorhexidine (1,1′-hexamethylene-bis-(5-(4′-chlorophenyl)-biguanide) and 3,4,4′-trichlorocarbanilide. Quaternary ammonium compounds are also suitable in principle. In view of their strong antimicrobial activity, all these substances are preferably used in low concentrations of about 0.1 to 0.3% by weight. In addition, many odoriferous substances also have antimicrobial properties. Consequently, such odoriferous substances with antimicrobial properties are preferably used in deodorants. Farnesol and phenoxyethanol are to be particularly mentioned in this connection. Therefore, it is particularly preferred when the deodorants according to the invention comprise odoriferous substances that are themselves bacteriostatic. The odoriferous substances may preferably again be present in the form of silicon compounds according to the invention. However, it is also possible that these antibacterial odoriferous substances need not be used in the form of silicon compounds according to the invention but rather are used in mixtures with other odoriferous substances that are present in the form of such silicon compounds. Another group of key ingredients of deodorants are enzyme inhibitors that inhibit the decomposition of perspiration by enzymes such as, for example, citric acid triethyl ester or zinc glycinate. Other key ingredients of deodorants are antioxidants that are intended to prevent the ingredients of perspiration from oxidizing.

According to a further likewise preferred embodiment of the invention, the cosmetic preparation is a hair setting preparation that comprises polymers for setting. In this connection, it is particularly preferred when at least one of the comprised polymers is a polyurethane.

In a preferred embodiment, the preparations according to the invention may comprise water-soluble polymers from the group of non-ionic, anionic, amphoteric and zwitterionic polymers.

Water-soluble polymers in the context of the invention are polymers of which more than 2.5% by weight dissolves in water at room temperature.

According to the invention, preferred water-soluble polymers are non-ionic. Suitable non-ionic polymers are, for example:
polyvinyl pyrrolidones, as are marketed, for example, under the designation Luviskol® (BASF). In the context of the invention, polyvinyl pyrrolidones are preferred non-ionic polymers.
vinyl pyrrolidone-vinyl ester copolymers, such as, for example, those marketed by BASF under the trade name Luviskol®, Luviskol® VA 64 and Luviskol® VA 73, each vinyl pyrrolidone-vinyl acetate copolymers, are particularly preferred non-ionic polymers.
cellulose ethers, such as hydroxypropyl cellulose, hydroxyethyl cellulose, and methyl hydroxypropyl cellulose, as marketed for example under the trademarks Culminal® and Benecel® (AQUALON).

Suitable amphoteric polymers are, for example, the octylacrylamide methyl methacrylate tert-butylaminoethyl methacrylate 2-hydroxypropyl methacrylate copolymers available under the designations Amphomer® and Amphomer® LV-71 (DELFT NATIONAL).

Suitable zwitterionic polymers are, for example, the polymers disclosed in German patent applications DE 39 29 973, DE 21 50 557, DE 28 17 369 and DE 37 08 451. Acrylamidopropyl trimethyl ammonium chloride/(meth)acrylic acid copolymers and alkali metal and ammonium salts thereof are particularly preferred zwitterionic polymers. Other suitable zwitterionic polymers are the methacroylethyl betainelmethacrylate copolymers commercially obtainable under the name of Amersette® (AMERCHOL). Suitable anionic polymers according to the invention are inter alia:
vinyl acetate-crotonic acid copolymers, such as, for example, commercialized under the designations Resyn® from National Starch Co., Luviset® from BASF and Gafset® from GAF.
vinyl pyrrolidone-vinyl acrylate copolymers, available for example from BASF under the trade name Luviflex®. A preferred polymer is the vinyl pyrrolidone/acrylate terpolymer obtainable under the name of Luviflex® VBM-35 (BASF).
acrylic acid-ethyl acrylate-N-tert-butylacrylamide terpolymers, which are marketed for example under the designation Ultrahold® strong (BASF).

In cases where the polyurethane contains ionic groups, it has proved to be useful for other water-soluble polymers to be non-ionic or to have the same ionicity.

The hair treatment preparations according to the invention preferably comprise water-soluble polymers in quantities of 0.01 to 20% by weight and more particularly in quantities of 0.1 to 10% by weight (based on the preparation as a whole) according to the particular type of hair treatment preparation.

The polyurethanes and the water-soluble polymers are preferably comprised in the preparations according to the invention in a quantity ratio of 1:10 to 10:1. A quantity ratio of 2:1 to 1:1 has proved to be particularly suitable in many cases.

The hair setting preparations according to the invention are in particular setting lotions, hair sprays and setting gels. Hair sprays are a particularly preferred embodiment of the hair selling preparations according to the invention.

In another preferred embodiment, the preparations according to the invention may also be formulated as a foam aerosol using a propellent.

Other constituents of the compositions according to the invention may be, for example:
anionic surfactants such as, for example, fatty alkyl sulfates and ether sulfates,
cationic surfactants, such as for example quaternary ammonium compounds,
zwitterionic surfactants such as, for example, betaines,
ampholytic surfactants,
non-ionic surfactants, such as for example alkyl polyglycosides and ethoxylated fatty alcohols,
structurants such as glucose and maleic acid,
hair conditioning compounds like phospholipids, for example soya lecithin, egg lecithin and cephalin, as well as silicone oils,
protein hydrolyzates, particularly those of elastin, collagen, keratin, milk protein, soya protein and wheat protein, their condensation products with fatty acids as well as quaternized protein hydrolyzates,
perfume oils that comprise the silicone compounds according to the invention,
solubilizers, such as ethylene glycol, propylene glycol, glycerine and diethylene glycol,
dyes,
anti-dandruff active materials like piroctone olamine and zinc omadine, further substances for adjusting the pH,
active substances, such as panthenol, allantoin, pyrrolidone carboxylic acids and salts thereof,
plant extracts and vitamins,
UV stabilizers,
thickeners like sugar esters, polyol esters or polyol alkyl ethers,
fats and waxes like spermaceti, beeswax, montan wax, paraffins, and fatty alcohols, fatty acid alkanolamides,
chelating agents like EDTA, NTA and phosphonic acids,
swelling and penetration compositions such as glycerine, propylene glycol monoethyl ether, carbonates, hydrogen carbonates, guanidines, ureas, and primary, secondary and tertiary phosphates,
blowing agents like propane-butane mixtures, N₂O, dimethyl ether, CO₂ and air, as well as
antioxidants.

As already mentioned, the hair setting preparations according to the invention preferably also contain polymers from the class of polyurethanes. The polyurethanes consist of at least two different types of monomer,
a compound (A) having at least 2 active hydrogen atoms per molecule and
a di- or polyisocyanate (B).

The compounds (A) may be, for example, diols, triols, diamines, triamines, polyetherols and polyesterols. The compounds containing more than 2 active hydrogen atoms are normally only used in small quantities in combination with a large excess of compounds containing 2 active hydrogen atoms.

Examples of compounds (A) are ethylene glycol, 1,2- and 1,3-propylene glycol, butylene glycols, di-, tri-, tetra- and poly-ethylene and -propylene glycols, copolymers of lower alkylene oxides, such as ethylene oxide, propylene oxide and butylene oxide, ethylenediamine, propylenediamine, 1,4-diaminobutane, hexamethylenediamine and α,ω-diamines based on long chain alkanes or polyalkylene oxides.

Polyurethanes where the compounds (A) are diols, triols and polyetherols may be preferred according to the invention. Polyethylene glycols and polypropylene glycols with molecular weights between 200 to 3 000 and more particularly between 1 600 to 2 500 have proved to be particularly suitable in some cases.

Polyesterols are normally obtained by modification of compound (A) with dicarboxylic acids, such as phthalic acid, isophthalic acid and adipic acid.

Hexamethylene diisocyanate, 2,4- and 2,6-toluene diisocyanate, 4,4′-methylene di(phenylisocyanate) and, in particular, isophorone diisocyanate are mainly used as the compounds (B).

In addition, the polyurethanes used in accordance with the invention may contain structural elements such as diamines, for example, as chain extenders and hydroxycarboxylic acids. Dialkylolcarboxylic acids such as dimethylolpropionic acid, for example, are particularly suitable hydroxycarboxylic acids. So far as the other structural elements are concerned, there is no basic limitation, i.e. they may be non-ionic, anionic or cationic structural elements.

Further information on the structure and production of polyurethanes can be found in articles in the relevant synoptic works, such as Römpps Chemie-Lexikon and Ullmanns Enzyklopdie der technischen Chemie.

Polyurethanes which have proved in many cases to be particularly suitable for the purposes of the invention may be characterized as follows:
only aliphatic groups in the molecule
no free isocyanate groups in the molecule
polyether- and polyester polyurethanes
anionic groups in the molecule.

It has also proved to be of advantage in some cases for the polyurethane to be stably dispersed and not dissolved in the system.

In addition, it has proved to be of advantage for the production of the preparations according to the invention if the polyurethanes are introduced in the form of aqueous dispersions, i.e. are not directly mixed with the other components. Such dispersions normally have a solids content of ca. 20-50% and more particularly ca. 35-45% and are also commercially available.

The hair setting preparations according to the invention preferably comprise the polyurethane in quantities of 0.1 to 15% by weight and more particularly 0.5 to 10% by weight, based on the preparation as a whole.

### EXAMPLES

In the following examples, “SAE” stands for silicic acid ester and “APSC” for aminopropyl silicon compound. The aminopropyl silicon compound is a silicon compound, in which an aminopropyl group is bonded to the silicon atom through a Si—C bond, and which moreover includes the cited fragrance alkoxy group.

A Laundry-Treatment Preparations/Detergents:

15 perfume oils were prepared with the compositions given in Tables 1 to 3 The composition of the perfume oils (‰, based on the total perfume oil) is given in the Tables 1 to 3:

TABLE 1
Perfume oils with flowery, ozony perfume notes (quantities in ‰)

| | Formula | Formula | Formula | Formula | Formula |
|---|---|---|---|---|---|
| Added Substance | 1a | 1b | 1c | 1d | 1e |
| Ethylene brassilate | 180 | 180 | 180 | 180 | 180 |
| ISO E Super | 135 | 135 | 135 | 135 | 135 |
| Hedione | 130 | 130 | 130 | 130 | 130 |
| Cyclohexyl salicylate | 100 | 100 | 100 | 100 | 100 |
| Henkel | | | | | |
| Lilial | 80 | 80 | 80 | 80 | 80 |
| Dihydro Beta-Ionone | 60 | 60 | 60 | 60 | 60 |
| Troenan Henkel | 60 | 60 | 60 | 60 | 60 |
| APSC-Citronellyl ester | 25 | 20 | 40 | 30 | 20 |
| Citronellyl SAE | 10 | 20 | 10 | 20 | 30 |
| Citronellol | 10 | 10 | — | — | — |
| APSC Geranyl ester | 25 | 40 | 15 | 30 | 20 |
| Geranyl SAE | 10 | 10 | 15 | 20 | 30 |
| Geraniol | 10 | — | 15 | — | — |
| Linalool | 37 | 37 | 37 | 37 | 37 |
| Helional | 34 | 34 | 34 | 34 | 34 |
| Eugenol pure | 10 | 10 | 10 | 10 | 10 |
| Canthoxal | 8 | 8 | 8 | 8 | 8 |
| Calone | 7 | 7 | 7 | 7 | 7 |
| Cyclovertal Henkel | 6 | 6 | 6 | 6 | 6 |
| Dimetol | 5 | 5 | 5 | 5 | 5 |
| Methyl anthranilate | 5 | 5 | 5 | 5 | 5 |
| 10% in DPG | | | | | |
| Decalactone Gamma | 4 | 4 | 4 | 4 | 4 |
| Phenylacetic acid | 3 | 3 | 3 | 3 | 3 |
| Damascenone | 3 | 3 | 3 | 3 | 3 |
| 10% in DPG | | | | | |
| Neroli Phase Oil | 3 | 3 | 3 | 3 | 3 |
| Cyclogalbanate | 2 | 2 | 2 | 2 | 2 |
| Indole | 1 | 1 | 1 | 1 | 1 |
| Isoeugenol methyl ether | 1 | 1 | 1 | 1 | 1 |
| Ambroxan Henkel | 1 | 1 | 1 | 1 | 1 |

TABLE 2
Perfume oils with fresh, rosy perfume notes (quantities in ‰)

| | Formula | Formula | Formula | Formula | Formula |
|---|---|---|---|---|---|
| Added Substance | 2a | 2b | 2c | 2d | 2e |
| Hexylcinnamaldehyde | 170 | 170 | 170 | 170 | 170 |
| (Alpha) | | | | | |
| Lilial | 170 | 170 | 170 | 170 | 170 |
| Ethyl linalool | 152 | 152 | 152 | 152 | 152 |
| APSC-Citronellyl ester | 50 | 60 | 100 | 100 | 100 |
| Citronellyl SAE | 50 | 40 | — | — | — |
| Ethylene brassilate | 80 | 80 | 80 | 80 | 80 |
| Benzyl acetate | 41 | 41 | 41 | 41 | 41 |
| Cyclohexyl salicylate | 40 | 40 | 40 | 40 | 40 |
| Henkel | | | | | |
| Citronellyl acetate | 40 | 40 | 40 | 40 | 40 |
| Acetoacetate ester | 34 | 34 | 34 | 34 | 34 |
| APSC Geranyl ester | 15 | 20 | 30 | 15 | 30 |
| Geranyl SAE | 15 | 10 | | 15 | — |
| APSC Phenylethyl ester | 15 | 20 | 30 | 15 | 15 |
| Phenylethyl SAE | 15 | 10 | | 15 | 15 |
| Geranium oil Bourbon | 20 | 20 | 20 | 20 | 20 |
| Linalool | 14 | 14 | 14 | 14 | 14 |
| Isoraldein 70 | 10 | 10 | 10 | 10 | 10 |
| Indoflor | 5 | 5 | 5 | 5 | 5 |
| Ethyl vanilin | 5 | 5 | 5 | 5 | 5 |
| 10% in DPG | | | | | |
| Rose oxide R | 5 | 5 | 5 | 5 | 5 |
| 10% in DPG | | | | | |
| Muguet Aldehyde 100 | 5 | 5 | 5 | 5 | 5 |
| Styryl acetate | 5 | 5 | 5 | 5 | 5 |
| Cumene aldehyde | 5 | 5 | 5 | 5 | 5 |
| 10% in DPG | | | | | |
| Calone 10% in DPG | 5 | 5 | 5 | 5 | 5 |
| Phenylacetal aldehyde | 5 | 5 | 5 | 5 | 5 |
| dimethylacetal | | | | | |
| Cyclovertal 10% in DPG | 5 | 5 | 5 | 5 | 5 |
| Henkel | | | | | |
| Petitgrain oil Parag. | 5 | 5 | 5 | 5 | 5 |
| Ethylphenyl acetate | 4 | 4 | 4 | 4 | 4 |
| Hexenyl acetate | 3 | 3 | 3 | 3 | 3 |
| Hexenol (Beta Gamma) | 3 | 3 | 3 | 3 | 3 |
| Hydratropa ald. | 2 | 2 | 2 | 2 | 2 |
| Dim. Acetal | | | | | |
| Phenylethyl | 1 | 1 | 1 | 1 | 1 |
| phenyl acetate | | | | | |
| Cyclogalbanate | 1 | 1 | 1 | 1 | 1 |
| Ambroxan Henkel | 1 | 1 | 1 | 1 | 1 |

TABLE 3
Perfume oils with fresh, green perfume notes (quantities in ‰)

| | Formula | Formula | Formula | Formula | Formula |
|---|---|---|---|---|---|
| Added Substance | 3a | 3b | 3c | 3d | 3e |
| Hexylcinnamaldehyde | 274 | 274 | 274 | 274 | 274 |
| (Alpha) | | | | | |
| Dipropylene glycol | 200 | 200 | 200 | 200 | 200 |
| Phenylethyl silicic | 50 | 60 | 100 | 100 | 100 |
| acid ester | | | | | |
| APSC Phenylethyl ester | 50 | 40 | | | |
| Bergamot oil Berg.-free | 100 | 100 | 100 | 100 | 100 |
| Cyclohexyl salicylate | 98.5 | 98.5 | 98.5 | 98.5 | 98.5 |
| Henkel | | | | | |
| Orange oil suss. ital. | 42 | 42 | 42 | 42 | 42 |
| Ethylene brassilate | 41 | 41 | 41 | 41 | 41 |
| Geranyl silicic | 15 | 20 | 30 | 15 | 30 |
| acid ester | | | | | |
| APSC Geranyl ester | 15 | 10 | | 15 | |
| Citronellyl silicic | 15 | 20 | 30 | 15 | 15 |
| acid ester | | | | | |
| APSC-Citronellyl ester | 15 | 10 | | 15 | 15 |
| Linalyl acetate | 20 | 20 | 20 | 20 | 20 |
| Litsea-Cubeba oil | 15 | 15 | 15 | 15 | 15 |
| Linalool | 12 | 12 | 12 | 12 | 12 |
| Pinene Beta P&F | 10 | 10 | 10 | 10 | 10 |
| Ionone Beta Synth. | 8 | 8 | 8 | 8 | 8 |
| Petitgrain oil Parag. | 7 | 7 | 7 | 7 | 7 |
| Muscatel Salvia oil | 3 | 3 | 3 | 3 | 3 |
| Cyclovertal Henkel | 3 | 3 | 3 | 3 | 3 |
| Danascone Beta | 2 | 2 | 2 | 2 | 2 |
| Allyl ionone (Ketone V) | 1 | 1 | 1 | 1 | 1 |
| Cedar leaf oil | 1 | 1 | 1 | 1 | 1 |
| Eucalyptus oil | 0.5 | 0.5 | 0.5 | 0.5 | 0.5 |

1% of perfume oils 1a and 1b were incorporated in a fabric softener concentrate containing 15% esterquats, the composition of which being shown in Table 4.

TABLE 4
Composition of the Fabric softener concentrate [wt. %].

| | |
|---|---|
| Dehyquart ® AU 46 | 15 |
| Perfume oil | 1 |
| Water, salts | Remainder |

Dehyquart ® AU 46 Dipalmitoleyl oxyethyl hydroxyethyl methylammonium methoxysulfate 90% conc. in isopropanol, commercial product of Henkel, Düsseldorf

B Cleaner:

### B1 Acidic Cleaner

Perfume oils with the compositions of Table 5 were produced. 5A is a perfume oil according to the invention and 5B is a comparative example.

TABLE 5
Perfume oils for an acidic cleaner with an apple fragrance

| Added Substance | 5A parts in ‰ | 5B parts in ‰ |
|---|---|---|
| Dynascone 10 | 5.0 | 5.0 |
| Cyclovertal | 7.5 | 7.5 |
| Hexyl acetate | 35.0 | 35.0 |
| Allyl heptanoate | 200.0 | 200.0 |
| Amyl butyrate | 5.0 | 5.0 |
| Prenyl acetatee | 10.0 | 10.0 |
| Aldehyde C 14 SOG | 70.0 | 70.0 |
| Manzanate | 15.0 | 15.0 |
| Melusat | 30.0 | 30.0 |
| Ortho tert Butylcyclohexyl acetate | 200.0 | 200.0 |
| Cinnamaldehyde | 5.0 | 5.0 |
| Isobornyl acetate | 10.0 | 10.0 |
| Dihydrofloriffone TD | 2.5 | 2.5 |
| Floramat | 100.0 | 100.0 |
| Phenylethyl alcohol | 30.0 | 30.0 |
| Geranyl silicic acid ester | — | 55.0 |
| APSC Geranyl ester | 105.0 | 55.0 |
| Cyclohexyl salicylate | 150.0 | 150.0 |
| Citronellol | 20.0 | 20.0 |

These perfume oils were incorporated into an acidic cleaner with a formulation according to Table 6.

TABLE 6
Formulation of the acidic cleaner [wt. %]

| | |
|---|---|
| ABS acid | 4.0 |
| Fatty alcohol ethoxylate (EO = 7) | 2.0 |
| KOH | 5.5 |
| Citric acid × 1H₂O | 10.5 |
| Soda calc. | 0.05 |
| Glutaraldehyde | 1.5 |
| Perfume | 1.5 |
| Deionized water sterilized | Remainder |
| pH | 4.4 |

B2 Multi-Purpose Cleaner

Perfume oils with formulations of Table 8 were incorporated in a multi-purpose cleaner (a 2-phase cleaner) having a formulation according to Table 7

TABLE 7
Formulations of the multi-purpose cleaner
(2-phase cleaner); Numbers in [wt. %]

| | |
|---|---|
| ABS acid | 4 |
| Fatty alcohol ethoxylate (EO = 7) | 2 |
| K0H | 4.5 |
| Citric acid × 1 H₂O | 4.75 |
| Cetiol ® OE | 4.5 |
| Soda calc. | 0.2 |
| Glutaraldehyde | 0.05 |
| Perfume | 1.6 |
| Deionized water sterilized | Remainder |
| pH | 10 |

TABLE 8
Perfume oils for a multi-purpose
cleaner with a lemon fragrance note

| Added Substance | 8A parts in ‰ | 8B parts in ‰ |
|---|---|---|
| Dihydromyrcenol | 30.0 | 30.0 |
| Aldinyle 3881 | 5.0 | 5.0 |
| Citral AR | 15.0 | 15.0 |
| Geranonitrile | 56.0 | 56.0 |
| Tridecene-2-nitrile 10% in DPG | 3.0 | 3.0 |
| Methylpamplemousse | 5.0 | 5.0 |
| Vertacetal | 2.0 | 2.0 |
| Citronellal | 10.0 | 10.0 |
| Citrathal | 10.0 | 10.0 |
| Orange oil distilled white | 480.0 | 480.0 |
| Methyl naphthyl ketone crystallized | 5.0 | 5.0 |
| Aldehyde C 08 | 10.0 | 10.0 |
| Aldehyde C 09 | 6.0 | 6.0 |
| Aldehyde C 10 | 15.0 | 15.0 |
| Cyclovertal | 7.0 | 7.0 |
| Hexenol (Beta Gamma) | 1.0 | 1.0 |
| Hexyl acetate | 6.0 | 6.0 |
| Camphor synthetic | 11.0 | 11.0 |
| Pine oil French 70 | 30.0 | 30.0 |
| Carvone L | 1.0 | 1.0 |
| Styryl acetate | 6.0 | 6.0 |
| Linalool | 30.0 | 30.0 |
| Phenylethyl alcohol | 20.0 | 20.0 |
| Citronellol | 25.0 | 25.0 |
| Geranyl acetate | 3.0 | 3.0 |
| Geranyl silicic acid ester | — | 65.0 |
| APSC Geranyl ester | 127.0 | 65.0 |
| Neryl acetate | 1.0 | 1.0 |
| Cyclohexyl salicylate | 70.0 | 70.0 |
| Sandelice | 5.0 | 5.0 |
| Boisambrene Forte | 3.0 | 3.0 |
| Ethyl vanillin 10% in DPG | 2.0 | 2.0 |

C Foam Bath

A shower bath is shown below as an example of a cosmetic skin care preparation. Table 9 shows the perfume oil compositions used in the foam bath having a formulation according to Table 10.

TABLE 9
Perfume oils with a fresh, flowery fragrance note

| Added Substance | 9A parts in ‰ | 9B parts in ‰ |
|---|---|---|
| Bergamot oil | 250.0 | 250.0 |
| Lemon oil Messina | 50.0 | 50.0 |
| Citronellal | 2.0 | 2.0 |
| Orange oil sweet | 50.0 | 50.0 |
| Lavender oil | 50.0 | 50.0 |
| Terpineol | 50.0 | 50.0 |
| Lilial | 100.0 | 100.0 |
| Phenylethyl alcohol | 80.0 | 80.0 |
| Citronellyl silicic acid ester | — | 50.0 |
| APSC-Citronellyl ester | 100.0 | 50.0 |
| Geraniol | 20.0 | 20.0 |
| Benzyl acetate | 60.0 | 60.0 |
| Isoraldein 70 | 50.0 | 50.0 |
| Ylang | 30.0 | 30.0 |
| Ambroxan 10% in IPM | 1.0 | 1.0 |
| Heliotropin | 47.0 | 47.0 |
| Habanolide | 60.0 | 60.0 |

TABLE 10
Composition of the foam bath

| Ingredients | [wt. %] |
|---|---|
| C₁₂₋₁₄ Fatty alcohol 2 EO sulfate | 8.0 |
| C₁₂₋₁₄ Fatty alcohol sulfosuccinate | 4.0 |
| Coco amide betain | 2.0 |
| Coco fatty acid monoglyceride 7 EO | 3.0 |
| Glycerine monolaurate | 2.0 |
| Protein hydrolyzate | 1.0 |
| Ethylene glycol distearate | 1.0 |
| Perfume oil | 1.0 |
| Water | Remainder |

D Soap

A bar of soap was produced with a composition corresponding to Table 12. In the example according to the invention, it comprised the fragrance composition 11A or 11B.

TABLE 11
Perfume oils with a fresh, flowery fragrance note

| Added Substance | 11A parts in ‰ | 11B parts in ‰ |
|---|---|---|
| Bergamot oil | 250.0 | 250.0 |
| Lemon oil Messina | 50.0 | 50.0 |
| Citronellal | 2.0 | 2.0 |
| Orange oil sweet | 50.0 | 50.0 |
| Lavender oil | 50.0 | 50.0 |
| Terpineol | 50.0 | 50.0 |
| Lilial | 100.0 | 100.0 |
| APSC Phenylethyl ester | 40.0 | 80.0 |
| Phenylethyl silicic acid ester | 40.0 | — |
| Citronellol | 100.0 | 100.0 |
| Geraniol | 20.0 | 20.0 |
| Benzyl acetate | 60.0 | 60.0 |
| Isoraldein 70 | 50.0 | 50.0 |
| Ylang | 30.0 | 30.0 |
| Ambroxan 10% in IPM | 1.0 | 1.0 |
| Heliotropin | 47.0 | 47.0 |
| Habanolide | 60.0 | 60.0 |

TABLE 12
Composition of the soap bar [wt. %]

| Added Substance | [wt. %] |
|---|---|
| Tallow fatty acid soap | 60 |
| Coco fatty acid soap | 27 |
| Glycerine | 2 |
| Perfume oil | 3 |
| Water | Remainder |

E Deodorant

Perfume oil compositions for a deodorant spray are shown in Table 13, the formulation of the deodorant in Table 14.

TABLE 13
Perfume oil for a deodorant spray with a
flowery fragrance reminiscent of peonies

| Added Substance | 22A parts in ‰ | 22B parts in ‰ |
|---|---|---|
| Petitgrain oil Paraguay | 5.0 | 5.0 |
| Cyclogalbanate | 1.0 | 1.0 |
| Hexenol (Beta Gamma) | 3.0 | 3.0 |
| Hexenyl acetate | 3.0 | 3.0 |
| Cyclovertal 10% in DPG | 5.0 | 5.0 |
| Phenylacetaldehyde dimethylacetal | 5.0 | 5.0 |
| Calone 10% in DPG | 5.0 | 5.0 |
| Acetoacetate ester | 35.0 | 35.0 |
| Cumene aldehyde 10% in DPG | 5.0 | 5.0 |
| Styryl acetate | 5.0 | 5.0 |
| Bourgeonal | 6.0 | 6.0 |
| Cyclamenaldehyde extra L.G. | 4.0 | 4.0 |
| Florol 943160 | 62.0 | 62.0 |
| Hydroxycitronellal pure | 12.0 | 12.0 |
| Lilial | 37.0 | 37.0 |
| Lyral | 61.0 | 61.0 |
| Nerolidol | 4.0 | 4.0 |
| Ethyl linalool | 152.0 | 152.0 |
| Linalool | 14.0 | 14.0 |
| Rose oil Turkey | 2.0 | 2.0 |
| Rose Wardia | 10.0 | 10.0 |
| Phenylethyl alcohol | 28.0 | 28.0 |
| Citronellyl acetate | 40.0 | 40.0 |
| Citronellyl silicic acid ester | 50.0 | — |
| APSC-Citronellyl ester | 50.0 | 106.0 |
| Geraniol | 10.0 | 10.0 |
| Phenylethyl acetate | 1.0 | 1.0 |
| Rose oxide R 10% in DPG | 5.0 | 5.0 |
| Geranium oil Bourbon | 20.0 | 20.0 |
| Benzyl acetate | 41.0 | 41.0 |
| Veloutone | 1.0 | 1.0 |
| Hedione | 100.0 | 100.0 |
| Hexylcinnamaldehyde (Alpha) | 70.0 | 70.0 |
| Hydratropa aldehyde dimethyl acetal | 2.0 | 2.0 |
| Isoraldein 70 | 9.0 | 9.0 |
| Cyclohexyl salicylate | 75.0 | 75.0 |
| Hexenyl salicylate (CIS-3) | 21.0 | 21.0 |
| Ethyl vanillin 10% in DPG | 5.0 | 5.0 |
| Ethylphenyl acetate | 4.0 | 4.0 |
| Phenylethylphenyl acetate | 1.0 | 1.0 |
| Ambrettolide | 3.0 | 3.0 |
| Cyclopentadecanolide | 2.0 | 2.0 |
| Ethylene brassilate | 15.0 | 15.0 |
| Indoflor | 5.0 | 5.0 |

TABLE 14
Formulation of the deodorant [wt. %]

| | |
|---|---|
| APG 600 | 0.050 wt. % |
| APG 220 | 0.150 wt. % |
| Cetiol ® OE | 0.030 wt. % |
| Eutanol ® G | 0.007 wt. % |
| Citric acid (cryst.) | 0.005 wt. % |
| Perfume oil | 0.300 wt. % |
| Aluminum hydroxy chloride | 20.000 wt. % |
| Boehmite (20% conc.) | 4.000 wt. % |
| Water | 75.460 wt. % |

APG 600: Plantacare 1200 UP (Henkel KGaA) Active substance: 50-53 wt. % Alkyl-C₁₂-C₁₆-oligo(1,4)-glucoside
APG 220: Plantacare 220 UP (Henkel KGaA) Aktive substance: 62-65 wt. % Alkyl-C₈-C₁₀-oligo(1,5)-glucoside
Cetiol ® OE Dioctyl ether (Henkel KGaA)
Eutanol ® G 2-Octyl-dodecanol (Henkel KGaA)

F Hair Spray

The compositions 15A and 15B represent a perfume oil according to the invention for a hair spray. These fragrant compositions were incorporated into a hair spray with the formulation reported in Table 16.

TABLE 15
Perfume oils for a hair spray with a flowery, fresh, spicy note

| Added Substance | 15A parts in ‰ | 15B parts in ‰ |
|---|---|---|
| Linalyl acetate | 28.0 | 28.0 |
| Lemon oil Messina | 44.0 | 44.0 |
| Methylpamplemousse | 0.5 | 0.5 |
| Cyclocalbanat | 0.5 | 0.5 |
| Cyclovertal | 1.0 | 1.0 |
| Hexenol (Beta Gamma) | 2.0 | 2.0 |
| Hexenyl acetate | 1.0 | 1.0 |
| Precyclemone B | 5.0 | 5.0 |
| Peranat | 5.0 | 5.0 |
| Terpineol | 3.0 | 3.0 |
| Styryl acetate | 2.0 | 2.0 |
| Lilial | 50.0 | 50.0 |
| Troenan | 27.0 | 27.0 |
| Ethyl linalool | 106.0 | 106.0 |
| Linalool | 36.0 | 36.0 |
| Helional | 40.0 | 40.0 |
| Phenylethyl alcohol | 10.0 | 10.0 |
| Citronellyl acetate | 5.0 | 5.0 |
| Citronellol | 35.0 | 35.0 |
| Geranyl silicic acid ester | 50.0 | — |
| APSC Geranyl ester | 50.0 | 100.0 |
| Geranium oil Bourbon | 10.0 | 10.0 |
| Jasmone-Cis | 2.0 | 2.0 |
| Hedione | 157.0 | 157.0 |
| Hexylcinnamaldehyde (Alpha) | 41.0 | 41.0 |
| Isoraldein 70 | 16.0 | 16.0 |
| Ionone Beta synthetic | 14.0 | 14.0 |
| Liffarome | 1.0 | 1.0 |
| Cyclohexyl salicylate | 6.0 | 6.0 |
| Patchouly oil | 3.0 | 3.0 |
| Sandelice | 26.0 | 26.0 |
| ISO E Super | 109.0 | 109.0 |
| Ambroxan | 1.0 | 1.0 |
| Vanillin | 2.0 | 2.0 |
| Ethylene brassilate | 110.5 | 110.5 |
| Indole | 0.5 | 0.5 |

TABLE 16
Formulation of the hair spray [wt. %]

| | |
|---|---|
| Alberdingk U ® 500 | 5.0 |
| Luviskol ® VA64 | 3.0 |
| Panthenol | 0.5 |
| Perfume oil | 1.0 |
| Dimethl ether | 40.0 |
| Water | ad 100 |

Alberdingk U 500: anionic polyether-polyurethane dispersion (40% in water) (ALBERDINGK BOLEY)
Luviskol VA64: vinyl acetate-vinyl pyrrolidone copolymer (BASF)

G Fragrance Tests

### G1 Citronellyl Derivatives

About 1% of each of the citronellol, monomeric citronellyl SAE, polymeric citronellyl SAE and citronellyl silyl aminopropane (APSC citronellyl ester) were incorporated into a fabric softener concentrate containing 15% esterquats, whose composition is given in Table 17, care being taken that the comprised amount of fragrance units is the same. The washing that had been washed with perfume-free universal detergent, was treated with 40 g of these fabric softeners in the last rinse cycle. After spin-drying, the smell of the damp laundry was evaluated, after which the laundry was hung out on a line to dry. The smell of the dry laundry was evaluated on removal from the washing line and after 7 days, the laundry being stored in plastic bags.

TABLE 17
Composition of the Fabric softener concentrate [wt. %]:

| | |
|---|---|
| Dehyquart ® AU 46 | 15 |
| Fragrance | 1 |
| Water, salts | Remainder |

Dehyquart ® AU 46 Dipalmitoleyloxyethyl-hydroxyethyl-methylammonium-methoxysuflate, 90% conc. in isopropanol, commercial product from Henkel, Düsseldorf

The laundry was evaluated for fragrance intensity by experts (perfumists) according to the following scale:
1=no appreciable fragrance
2=little appreciable fragrance
3=somewhat of a scent
4=pleasant scent
5=very pleasant scent
   The results of this test are shown in Table 18.

TABLE 18
Fragrance impression of citronellyl derivatives in
fabric softener concentrates

| | | monom. | polym. | |
|---|---|---|---|---|
| | | Citronellyl | Citronellyl | APSC-Citronellyl |
| Substance | Citronellol | SAE | SAE | ester |
| Added | 0.9 | 0.95 | 1.01 | 1.06 |
| concentration | | | | |
| in wt. % | | | | |
| Product | 4.6 | 2.4 | 2.6 | 4.4 |
| Damp laundry | 5.0 | 2.7 | 2.8 | 4.5 |
| Dry lauandry | 4.0 | 2.8 | 3.4 | 4.4 |
| Dry laundry after | 4.3 | 5.0 | 4.3 | 5.0 |
| 7 days | | | | |

About 0.4% of each of the citroneliol, monomeric citronellyl SAE, polymeric citronellyl SAE and citronellyl silyl aminopropane (APSC citronellyl ester) were added into a commercial, perfume-free detergent, care being taken that the comprised amount of fragrance units is the same. The laundry was washed at 60° C. with 150 gof these powders and rinsed three times with clear water. After spin-drying, the smell of the damp laundry was evaluated, after which the laundry was hung out on a line to dry. The smell of the dry laundry was evaluated immediately and after 7 days, the laundry being stored in plastic bags.

The intensity of the fragrance impression of the laundry was also evaluated by experts (perfumists). The results of this test are shown in Table 19.

TABLE 19
Fragrance impression of citronellyl derivatives in detergents

| | | Citronellyl | Citronellyl | APSC-Citronellyl |
|---|---|---|---|---|
| Substance | Citronellol | SAE | SAE | ester |
| Added | 0.4 | 0.42 | 0.45 | 0.47 |
| concentration | | | | |
| in wt. % | | | | |
| Product | 4.4 | 2.6 | 2.4 | 3.8 |
| Damp laundry | 4.2 | 2.8 | 2.7 | 3.7 |
| Dry laundry | 2.0 | 2.4 | 2.4 | 3.6 |
| Dry laundry after | 2.7 | 4.7 | 4.0 | 4.7 |
| 7 days | | | | |

The results clearly show that a more constant fragrance impression was achieved with the aminoalkyl substituted silicon compound than with the silicic acid esters. On adding the silicic acid ester with the same amount of fragrance units, a relatively lower fragrance impression is achieved in comparison with the aminoalkyl-substituted silicon compound, both in the product as well as immediately after washing, whereas a relatively stronger fragrance impression is achieved 7 days after washing. In contrast, on adding the aminoalkyl-substituted silicon compound, a consistently good fragrance impression is achieved both in the product as well as immediately after washing and also 7 days after washing. The results also clearly demonstrate that, due to their different release kinetics, aminoalkyl-substituted silicon compounds can be combined with silicic acid esters in order to achieve an advantageous fragrance impression.

G2 Menthyl Derivatives

About 1% of each of the menthol, monomeric menthyl SAE and menthyl silyl aminopropane (APSC menthyl ester) were incorporated into a fabric softener concentrate containing 15% esterquats, whose composition is given in Table 20, care being taken that the comprised amount of fragrance units is the same. The laundry that had been washed with perfume-free universal detergent, was treated with 40 g of these fabric softeners in the last rinse cycle. After spin-drying, the smell of the damp laundry was evaluated, after which the laundry was hung out on a line to dry. The smell of the dry laundry was evaluated on removal from the washing line and after 7 days, the laundry being stored in plastic bags.

TABLE 20
Composition of the fabric softener concentrate [wt. %]:

| | |
|---|---|
| Dehyquart ® AU 46 | 15 |
| Fragrance | 1 |
| Water, salts | Remainder |

Dehyquart ® AU 46 Dipalmitoleyloxyethyl-hydroxyethyl-methylammonium-methoxysulfate, 90% conc. in isopropanol, commercial product from Henkel, Düsseldorf

The laundry was evaluated for fragrance intensity by experts (perfumists) according to the following scale:

1=no appreciable fragrance
2=little appreciable fragrance
3=somewhat of a scent
4=pleasant scent
5=very pleasant scent
The results of this test are shown in Table 21.

TABLE 21
Fragrance impression of menthyl derivatives in fabric softener
concentrates

| | | Menthyl- | APSC-Menthyl |
|---|---|---|---|
| Substance | Menthol | SAE | ester |
| Added concentration in wt. % | 0.9 | 1.01 | 1.13 |
| Product | 5.0 | 2.8 | 4.6 |
| Damp laundry | 5.0 | 2.4 | 4.6 |
| Dry laundry | 2.0 | 2.0 | 2.3 |
| Dry laundry after 7 days | 1.7 | 1.7 | 3.3 |

The results also clearly show that a more consistent fragrance impression can be achieved with the aminoalkyl substituted silicon compound than with the silicic acid ester. On adding the silicic acid ester with the same amount of fragrance units, a relatively lower fragrance impression is achieved in comparison with the aminoalkyl-substituted silicon compound, both in the product as well as immediately after washing, whereas a relatively stronger fragrance impression is achieved 7 days after washing. In contrast, on adding the aminoalkyl-substituted silicon compound, a consistently good fragrance impression is achieved both in the product as well as immediately after washing and also 7 days after washing. In contrast, the non carrier-supported fragrance is released in very high amounts to begin with and then subsequently noticeably volatilises. The results also clearly demonstrate that, due to their different release kinetics, aminoalkyl-substituted silicon compounds can be combined with silicic acid esters in order to achieve an advantageous fragrance impression.

1-38. (canceled)

39. A silicon compound comprising at least one silicon atom, at least one alkoxy group of the formula —OR′ bonded to silicon, and at least one aminoalkyl group bonded to silicon, wherein the alkoxy group is derived from an active substance alcohol of the formula R′OH.

40. The silicon compound according to claim 39, wherein the active substance alcohol comprises one or more selected from the group consisting of fragrance alcohols and biocide alcohols.

41. The silicon compound according to claim 39, wherein the silicon compound corresponds to the general formula (I): 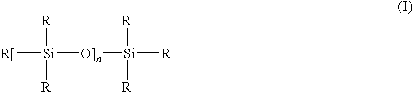
wherein at least one R represents the alkoxy group derived from an active substance alcohol; wherein at least one other R represents the aminoalkyl group; and wherein each of the remaining R groups independently represents a hydrogen, a hydroxyl, an alkyl, an alkoxy group, or two remaining R groups bound to different silicon atoms represent an oxygen atom that bridges the two different silicon atoms; and wherein n represents a number of 0 to 20.

42. The silicon compound according to claim 41, wherein n represents zero, one R group represents the aminoalkyl group, and each of the remaining R groups independently represents an alkoxy group, at least one of which is an alkoxy group —OR′ derived from an active substance alcohol.

43. The silicon compound according to claim 41, wherein n represents zero, one R group represents the aminoalkyl group, and each of the remaining R groups independently represents an alkoxy group, at least two of which are alkoxy groups —OR′ derived from an active substance alcohol.

44. The silicon compound according to claim 41, wherein each of the remaining R groups independently represents a C₁₋₄ alkyl or a C₁₋₄ alkoxy group.

45. The silicon compound according to claim 41, wherein n represents a number of 1 to 14.

46. The silicon compound according to claim 39, wherein the at least one aminoalkyl group is bonded to silicon via an Si—C bond.

47. The silicon compound according to claim 39, wherein the at least one aminoalkyl group comprises an aminoalkoxy group.

48. The silicon compound according to claim 39, wherein each of the at least one aminoalkyl group is independently selected from the group consisting of aminomethyl, aminoethyl, amino-n-propyl, amino-isopropyl, amino-n-butyl, amino-iso-butyl, and amino tert-butyl.

49. The silicon compound according to claim 39, wherein the active substance alcohol of the formula R′OH comprises one or more fragrance alcohols selected from the group consisting of 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 1-octen-3-ol, 3-phenylpropanol, 4-heptenol, 4-isopropylcyclohexanol, 4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, β-terpineol, butyl salicylate, citronellol, cyclohexyl salicylate, decanol, dihydromyrcenol, dimethylbenzylcarbinol, dimethylheptanol, dimethyloctanol, ethyl salicylate, ethyl vanillin, eugenol, geraniol, heptanol, hexyl salicylate, isoborneol, isoeugenol, isopulegol, linalool, menthol, myrtenol, n-hexanol, nerol, nonanol, octanol, para-menthan-7-ol, phenylethyl alcohol, phenol, phenyl salicylate, tetrahydrogeraniol, tetrahydrolinalool, thymol, trans-2-cis-6-nonadienol, trans-2-nonen-1-ol, trans-2-octenol, undecanol, vanillin, and cinnamyl alcohol.

50. The silicon compound according to claim 39, comprising two or more alkoxy groups derived from the same active substance alcohol of the formula R′OH.

51. The silicon compound according to claim 39, comprising two or more identical aminoalkyl groups.

52. The silicon compound according to claim 39, wherein the at least one aminoalkyl group is quaternized.

53. The silicon compound according to claim 39, further comprising an aldehyde, in the form of a Schiffs base, bonded to the amino moiety of the at least one aminoalkyl group.

54. The silicon compound according to claim 53, wherein the aldehyde comprises a fragrance aldehyde.

55. A composition comprising a silicon compound according to claim 39.

56. The composition according to claim 55, wherein the silicon compound is present in an amount of 0.001 to 10 wt. %, based on the composition.

57. The composition according to claim 55, further comprising an fragrance-releasing compound.

58. The composition according to claim 57, wherein the fragrance-releasing compound comprises a silicic acid ester of a fragrance alcohol.
